(19) United States
(12) Patent Application Publication
(10) Pub. No.: US 2022/0066337 A1
(43) Pub. Date: Mar. 3, 2022

(54) IMAGE FORMING METHOD AND IMAGE FORMING SYSTEM

(71) Applicant: Konica Minolta, Inc., Tokyo (JP)

(72) Inventors: Akihiko ITAMI, Tokyo (JP); Seijiro TAKAHASHI, Tokyo (JP); Seisuke MAEDA, Tokyo (JP)

(21) Appl. No.: 17/395,098

(22) Filed: Aug. 5, 2021

(30) Foreign Application Priority Data
Aug. 25, 2020 (JP) 2020-141464

(51) Int. Cl. G03G 9/08; G03G 9/087; G03G 9/093

(52) U.S. Cl. CPC G03G 9/0819; G03G 9/09392; G03G 9/08797

(57) ABSTRACT

An image forming method uses an electrophotographic photoreceptor and a toner for developing an electrostatic charge image. The image forming method has a charging step, an exposure step, a developing step, a transfer step and a cleaning step, wherein the charging step uses a contact charging device; the photoreceptor has a universal hardness value (HU) of 170 N/mm² or more, and an elastic deformation ratio of 40% or more when a Vickers indenter is used in a predetermined environment and pushed by a maximum load of 2 mN. The toner for developing an electrostatic charge image contains toner base particles of a core-shell structure having a shell layer of 10% by mass or less with respect to a mass of a toner base particle on an outside of a resin constituting a core particle, and a solubility parameter value (SPs) of a resin constituting the shell layer is 10.75 or less.

### CROSS-REFERENCE TO RELATED APPLICATION

The entire disclosure of Japanese Patent Application No. 2020-141464 filed on Aug. 25, 2020 is incorporated herein by reference in its entirety.

### BACKGROUND

### Technological Field

The present invention relates to an image forming method and an image forming system. More particularly, the present invention relates to an image forming method and an image forming system which are excellent in low-temperature fixing property, transfer property, and cleaning property, and may stably form a high-quality image over a long period of time in a contact charging system.

### Description of the Related Art

In recent years, in order to meet the needs for high image quality and low-temperature fixing property, the toner has been made smaller in diameter, monodisperse, spherical, and low in glass transition temperature (low Tg). On the other hand, since these measures reduce the cleaning property of the toner remaining on the photoreceptor, surface design for improving the cleaning property of the surface of the photoreceptor has been carried out (for example, refer to Patent Documents 1 to 3).
Patent Document 1: JP-A 2015-127818
Patent Document 2: JP-A 2010-237540
Patent Document 3: JP-A 2010-139986

By controlling the physical properties of the surface of the photoreceptor, the surface is resistant to abrasion and scratches, thereby suppressing an increase in surface roughness and ensuring cleaning property over a long period of time.

On the other hand, in recent years, the contact charging system, which is compact and excellent in energy saving, has become popular, especially for models for offices. The contact charging method has the merit that generation of harmful gas such as ozone is small because it discharges directly onto the surface of the photoreceptor, but the outermost surface of the photoreceptor is liable to be hydrophilic by the influence of oxidation by direct discharge. Further, a photoreceptor surface having small abrasion has caused a problem in that an oxidized surface or an adhered matter is hardly removed, and as a result, the photoreceptor surface becomes hydrophilic and a transfer property of a toner is lowered. Further, in the toner having a thin film shell, in an image pattern such as an isolated dot in which stress tends to concentrate at the time of transfer, there is a problem that the toner is apt to coalesce with respect to each other, and an image defect such as void formation in which the coalesced toner at the center portion of the isolated dot is not transferred is apt to occur.

### SUMMARY

The present invention has been made in view of the above problems and status. An object of the present invention is to provide an image forming method and an image forming system which are excellent in low temperature fixing property, transfer property, and cleaning property in a contact charging method, and which may stably form a high-quality image over a long period of time.

In order to solve the above-mentioned problems, the present inventors have found the following in the process of examining the causes of the above-mentioned problems. That is, it has been found that by setting the universal hardness value and the elastic deformation ratio of the outermost layer of the photoreceptor in a specific range, and by making the toner to have a thin shell layer, and the solubility parameter value of the resin of the shell layer is defined, not only the cleaning property but also the low-temperature fixing property in the contact charging method are excellent, and the transfer property may be ensured for a long period of time, and the present invention has been achieved. In other words, the above problem according to the present invention is solved by the following embodiments.

To achieve at least one of the above-mentioned objects of the present invention, an image forming method that reflects an aspect of the present invention is as follows.

An image forming method using an electrophotographic photoreceptor and a toner for developing an electrostatic charge image, and having at least a charging step, an exposure step, a developing step, a transfer step and a cleaning step, wherein the charging step is a step using a contact charging device; in an outermost layer of the electrophotographic photoreceptor, a universal hardness value (HU) of the photoreceptor is 170 N/mm² or more, and an elastic deformation ratio of the photoreceptor is 40% or more when a Vickers indenter is used in an environment of 25° C. and a relative humidity of 50% and pushed by a maximum load of 2 mN; and the toner for developing an electrostatic charge image contains toner base particles of a core-shell structure having a shell layer of 10% by mass or less with respect to a mass of the toner base particle on an outside of a resin constituting a core particle, and a solubility parameter value (SPs) of a resin constituting the shell layer is 10.75 or less.

According to the above-mentioned embodiment of the present invention, it is possible to provide an image forming method and an image forming system which are excellent in low-temperature fixing property, transfer property, and cleaning property, and may stably form a high-quality image over a long period of time in the contact charging method. The expression mechanism or the action mechanism of the effect of the present invention is not clarified, but is inferred as follows. In order to achieve both the low-temperature fixing property and the heat storage resistance of the toner, it is advantageous to form a shell layer as a thin layer, and in the present invention, by using the toner containing the toner base particles having a shell layer of 10% by mass or less with respect to the mass of the toner base particle on an outside of the resin constituting a core particle, the low-temperature fixing property and the heat storage resistance are excellent. However, when scratches or abrasions occur on the photoreceptor or the surface is deteriorated by discharge, the cleaning property is deteriorated. In particular, in a toner base particle having a thin shell layer, a core particle having a low glass transition temperature is likely to be exposed, and toner filming (rain drop) is likely to occur. Therefore, in the present invention embodiment, by using a photoreceptor having a universal hardness value (HU) of not less than 170 N/mm² and an elastic deformation ratio of not less than 40% as the photoreceptor when the photoreceptor is pressed by a maximum load of 2 mN, the surface of the photoreceptor becomes high hardness and high elasticity, and the surface of the photoreceptor is hardly deteriorated by scratches, wear, or discharge, and the cleaning property becomes good. However, when the surface of the photoreceptor becomes high in strength and low in abrasion, a surface having a high hydrophilicity stays constantly due to surface deterioration or the influence of an adhering substance, and the adhering force of the toner increases and the transferability decreases. Therefore, in the present invention, further, in the toner, by setting the solubility parameter value (SPs) of the resin constituting the shell layer to 10.75 or less, the surface of the toner particle becomes hydrophobic, and the adhesion force of the toner is reduced and the transferability is improved with respect to the photoreceptor having a hydrophilic surface. As described above, by combining the photoreceptor having the universal hardness of not less than 170 N/mm² and the elastic deformation ratio of not less than 40% with the toner having a thin shell layer made of a resin constituting the shell layer having a solubility parameter value of not more than 10.75, in the contact charging method, it is possible to stably form high-quality images with excellent low-temperature fixing property, transfer property, and cleaning property over a long period of time.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram for explaining a method of calculating an elastic deformation ratio according to the present invention.

FIG. 2 is a cross-sectional view showing an example of a layer structure of an electrophotographic photoreceptor according to the present invention.

FIG. 3A is a schematic diagram showing the structure of the toner base particle according to the present invention.

FIG. 3B is a schematic diagram showing the structure of the toner base particle according to the present invention.

FIG. 3C is a schematic diagram showing the structure of the toner base particle according to the present invention.

FIG. 4 is a cross-sectional schematic view of an example of an electrophotographic image forming apparatus used in the image forming method of the present invention.

FIG. 5 is a diagram for explaining an example.

FIG. 6 is a diagram for explaining an example.

### DETAILED DESCRIPTION OF THE EMBODIMENTS

Hereinafter, one or more embodiments of the present invention will be described. However, the scope of the invention is not limited to the disclosed embodiments.

The image forming method of the present invention uses an electrophotographic photoreceptor and a toner for electrostatic charge image development, and has at least a charging step, an exposure step, a developing step, a transfer step, and a cleaning step, wherein the charging step is a step using a contact charging device; in an outermost layer of the electrophotographic photoreceptor, a universal hardness value (HU) of the photoreceptor is 170 N/mm² or more and an elastic deformation ratio of the photoreceptor is 40% or more when a Vickers indenter is used in an environment of 25° C. and a relative humidity of 50% and pushed by a maximum load of 2 mN; and the toner for developing an electrostatic charge image contains toner base particles of a core-shell structure having a shell layer of 10% by mass or less with respect to a mass of the toner base particle on an outside of a resin constituting a core particle, and a solubility parameter value (SPs) of a resin constituting the shell layer is 10.75 or less. This feature is a technical feature common to or corresponding to each of the following embodiments.

In an embodiment of the present invention, it is preferable that a glass transition temperature of a resin constituting the shell layer is higher than a glass transition temperature of a resin constituting the core particle, and an absolute value of a difference (SPs-SPc) between a solubility parameter value (SPs) of a resin constituting the shell layer and a solubility parameter value (SPc) of a resin constituting the core particle is within a range of 0.20 to 0.70. As a result, the SP value difference between the core particle and the shell layer becomes large, the core particle and the shell layer become incompatible with each other, an interface between the core particle and the shell layer is formed, and a clear core-shell structure is formed. Therefore, the core particles are less likely to be exposed to the surface of the toner base particles, so that aggregation between toner particles may be prevented, and not only the transfer efficiency of the solid image portion may be improved, but at the same time, it is also possible to suppress transfer defects (void formation) under severe conditions for the toner having a thin shell layer such as forming isolated dots.

It is preferable that the universal hardness value (HU) is in the range of 200 to 280 N/mm² and the elastic deformation ratio is in the range of 45 to 60%. Thus, the surface of the photoreceptor has a high hardness and high elasticity, and the cleaning property of the toner becomes better.

Further, it is preferable that the outermost layer of the electrophotographic photoreceptor contains a polymerized product of a charge transport material having a polymerizable reactive group in view of large design of the elastic deformation ratio of the outermost layer of the photoreceptor.

The image forming system of the present invention is an image forming system using a toner for developing an electrostatic charge image and an electrophotographic photoreceptor, and having at least a charging step, an exposure step, a developing step, a transfer step and a cleaning step, and is characterized in that the image forming method of the present invention is performed. As a result, it is possible to provide an image forming system which is excellent in low-temperature fixing property, transfer property, and cleaning property, and may stably form a high-quality image over a long period of time.

Hereinafter, the present invention, its constituent elements, and constitutions and embodiments for carrying out the present invention will be described. In the present description, when two figures are used to indicate a range of value before and after “to”, these figures are included in the range as a lowest limit value and an upper limit value.

### Outline of the Image Forming Method of the Present Invention

The image forming method of the present invention uses an electrophotographic photoreceptor (hereinafter, it may be simply referred to a “photoreceptor”) and a toner for developing an electrostatic charge image (hereinafter, it may be simply referred to a “toner”). It is an image forming method that uses a charging step, an exposure step, a developing step, a transfer step, and a cleaning step, and the charging step uses a contact charging device. In an outermost layer of the electrophotographic photoreceptor, a universal hardness value (HU) of the photoreceptor is 170 N/mm² or more and an elastic deformation ratio of the photoreceptor is 40% or more when a Vickers indenter is used in an environment of 25° C. and a relative humidity of 50% and pushed by a maximum load of 2 mN; and the toner for developing an electrostatic charge image contains toner base particles of a core-shell structure having a shell layer of 10% by mass or less with respect to a mass of the toner base particle on an outside of a resin constituting a core particle, and a solubility parameter value (SPs) of a resin constituting the shell layer is 10.75 or less.

<Universal Hardness Value and Elastic Deformation Ratio>

The electrophotographic photoreceptor according to the present invention has a universal hardness (HU) of 170 N/mm² or more and an elastic deformation ratio of 40% or more when a Vickers indenter is used in an environment at a temperature of 25° C. and a humidity of 50% and pushed by a maximum load of 2 mN. The universal hardness is more preferably in the range of 200 to 280 N/mm². If it is less than or equal to 280 N/mm², it is possible to prevent a fragile film, and it is also possible to prevent a crack in a small-sized drum. The elastic deformation ratio is preferably in the range of 45 to 60%. If it is 60% or less, the adhesion with the cleaning blade does not become too good, and it is possible to prevent the occurrence of blade turning.

The universal hardness value and the elastic deformation ratio were measured at arbitrary five points from the image forming region in the outermost surface layer of the photoreceptor as shown below, and the average value thereof was obtained. Note that the outermost layer of the photoreceptor in the present invention will be described later, and examples thereof include a surface protective layer and a charge transport layer.

(Calculation Method of Universal Hardness Value (HU))

In the present invention, the universal hardness value (HU) is defined by the following equation (1) and equation (2).

$$\begin{matrix}HU = \frac{F}{A ( h )} = \frac{F}{26.43 \times {h}^{2}} & Equation ( 1 ) \\ A ( h ) = \frac{4 \times sin ( a \text{/} 2 )}{{cos}^{2} ( a \text{/} 2 )} \times {h}^{2} & Equation ( 2 )\end{matrix}$$

In the above equation (1) and equation (2), F is a test load (N), A(h) is a surface area (mm²) where the indenter contacts the object to be measured, and h is a depth of indentation (mm) when the test load is applied. A(h) is calculated from the shape of the indenter and the indentation depth, and when the indenter is a Vickers indenter, it is calculated from the angle a (136°) of the opposing faces of the pyramidal penetrator to be 26.43×h². The universal hardness values (HUs) may be measured using a commercially available hardness measuring device, and are measured using an ultra-micro hardness meter “H-100V” (manufactured by Fischer Instruments K.K.) under the following measurement condition. [Measurement conditions]

Measuring instrument: Ultra-micro hardness meter “H-100V” (manufactured by Fischer Instruments K.K.)

Indenter shape: Vickers indenter (a=136°)

Measurement environment: 25° C., relative humidity 50% RH

Maximum test load: 2 mN

Load speed: 2 mN/l0 sec

Maximum load creep time: 5 seconds

Removal speed: 2 mN/10 sec

(Calculation Method of Elastic Deformation Ratio)

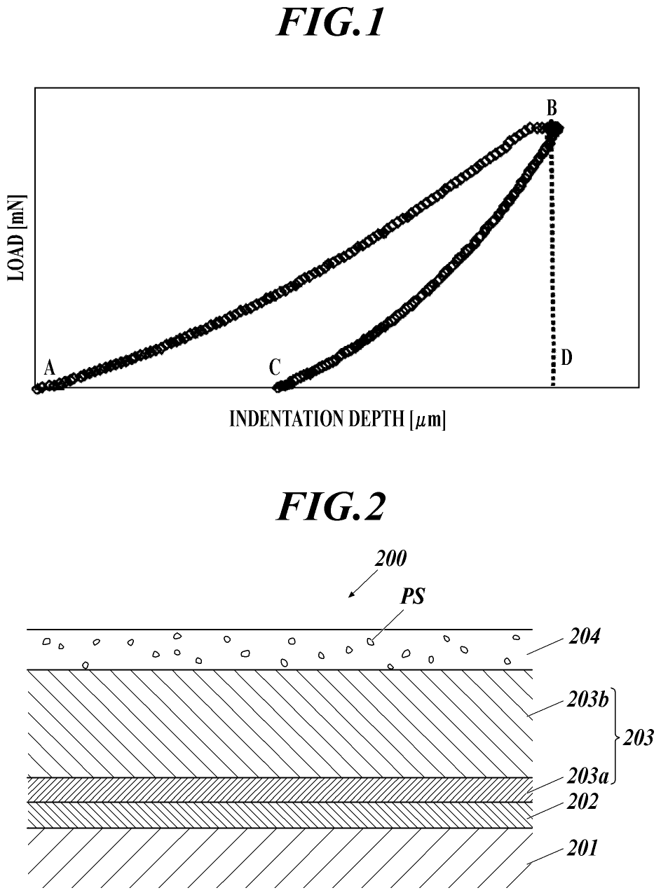

The elastic deformation ratio was obtained by using a Fischer Scope H-100 (manufactured by Fischer Instruments K.K.) under conditions of 25° C. and 50% RH. When a Vickers quadrangular pyramid indenter is used to apply a load of 2 mN to the outermost layer and the lower layer of the photoreceptor with holding for 5 seconds, then unloaded for 10 seconds, and the indentation depth and load are measured, it is expressed as shown in FIG. 1 (A→B→C).

The work of the elastic deformation Welast is expressed by the area surrounded by C-B-D-C in FIG. 1, the work of the plastic deformation Wplast is expressed by the area surrounded by A-B-C-A in FIG. 1, and the elastic deformation ratio (%) is obtained from (Welast/(Welast+Wplast)×100.

Means for making the universal hardness value 170 N/mm² or more and the elastic deformation ratio 40% or more include: increasing the entanglement density of the binder resin by means of increasing the molecular weight of the binder resin contained in the outermost surface layer of the photoreceptor, introducing branched structures, or three-dimensional crosslinking; increasing the entanglement density by means of intermolecular crosslinking, in the same manner as in the case when a charge transport material having a polymerizable reactive group is used in the outermost surface layer of the photosensitive member; and filling the outermost surface layer of the photosensitive member with additives such as fillers and fibers of high strength.

<Shell Layer>

The toner according to the present invention contains toner base particles having a core-shell structure, has a shell layer of 10% by mass or less based on the mass of the toner base particle on the outside of the resin constituting the core particle, and has a solubility parameter value (SPs) of 10.75 or less of the resin constituting the shell layer. The ratio of the shell layer is more preferably 6% by mass or less. Further, it is more preferable that the solubility parameter value of the resin constituting the shell layer is within a range of 9.8 to 10.25.

(Calculation Method of Solubility Parameter Value)

The solubility parameter value of each resin of the core particles and the shell layer constituting the toner base particles may be obtained from the composition of the constituent resins. The solubility parameter value of each resin is calculated from the product of the solubility parameter value and the molar ratio of each monomer constituting the resin. For example, when it is assumed that the copolymer resin is composed of 2 kinds of monomers of X and Y, if the mass composition ratio of each monomer is x and y (% by mass), the molecular weight is Mx and My, and the solubility parameter value is SPx and SPy, the respective monomer ratios become x/Mx and y/My. Here, when the molar ratio of the copolymer resin is C, C is defined as C=x/Mx+y/My, the solubility parameter value SP of this copolymer resin becomes as in the following equation (A).

SP={(x×SPx/Mx)+(y×SPy/My)}×1/C Equation (A):

The solubility parameter value (SP value) of the monomer is determined as follows. When calculating the solubility parameter value (SP value) of a monomer A, calculate the evaporation energy (Δei) and the molar volume (Δvi) from “Polym. Eng, Sci. Voll 14. p 114 (1974)” proposed by Fedors with respect to the atoms or groups of atoms in the molecular structure of the monomer, and calculate from the following equation (B), except that for the double bond which is cleaved upon polymerization, the cleaved state is defined as its molecular structure.

σ=(ΣΔei//Δvi)^{1/2} Equation (B):

The solubility parameter values of each of the following monomers are determined by the above calculation method.

Styrene: 10.55

Butyl acrylate: 9.77

2-Ethylhexyl methacrylate: 9.04

2-Ethylhexyl acrylate: 9.22

Methyl methacrylate: 9.93

Methacrylic acid: 12.54

Acrylic acid: 14.04

Using these values, and according to the above equation (A), the solubility parameter value of the copolymer is determined.

When the calculation formula of the above equation (B) cannot calculate the solubility parameter value of the monomer, specific values are described in the literature such as the 4th edition of the Polymer Handbook (published by Wiley) or the item of the solubility parameter value (http://polymer.nims.go.jp/guide/guide/p. 5110. html) described in the database Polylnfo (http://polymer.nims.go.jp) provided by the National Institute for Materials Science.

In the toner according to the present invention, among the solubility parameter value (SPc) of the resin forming the core particle and the solubility parameter value (SPs) of the resin forming the shell layer, the absolute value of the difference in solubility parameter value (SPc) of core particle having the solubility parameter value farthest from the solubility parameter value of the shell layer defined in the following is preferably in the range of 0.20 to 0.70: ΔSP=|(SPs)−(SPc)|. When ΔSP is in the range of 0.20 to 0.70, the core particle and shell layer are immiscible, an interface between the core particle and shell layer is formed, and a distinct core shell structure is formed. Therefore, the core particle is less likely to be exposed to the surface of the toner base particle, so that aggregation between toner base particles may be prevented, and not only the transfer efficiency of the solid mage portion may be improved, but it is also possible to suppress transfer defects (void formation) under severe conditions for toner having a thin shell layer such as forming isolated dots.

The solubility parameter value of each resin may be controlled by appropriately selecting the type of the polymerizable monomers that form the copolymer and the ratio thereof. Therefore, as a means for setting the solubility parameter value (SPs) of the resin constituting the shell layer to 10.75 or less, for example, it is preferable to control the content of styrene and methyl methacrylate of a monomer for producing a styrene-acrylic resin constituting the shell layer. Specifically, by increasing the content of styrene, SPs may be increased, and by increasing the content of methyl methacrylate, SPs may be reduced.

The image forming method of the present invention has at least a charging step of charging the photoreceptor, an exposure step of exposing the photoreceptor to form an electrostatic charge image, a developing step of developing the electrostatic charge image with a toner, a transfer step of transferring the developed toner image, and a cleaning step of cleaning the photoreceptor after the transfer step. The image forming method preferably further includes a fixing step of fixing the toner image transferred to the transfer material. Hereinafter, each step will be described.

<Charging Step>

The charging step is a step of charging the photoreceptor by applying a uniform potential to the photoreceptor. In the charging step, the photoreceptor is charged by using a contact charging roller.

<Exposure Step>

The exposure step is a step of performing exposure based on an image signal on the photoreceptor to which a uniform potential is given by the charging step, and forming an electrostatic charge image corresponding to the image. As the exposure means, an LED in which light emitting elements are arranged in an array in the axial direction of the photoreceptor and an imaging element, or a laser optical system is used.

<Developing Step>

The developing step is a step of developing the electrostatic charge image with a dry developer containing the toner according to the present invention to form a toner image. The formation of the toner image is performed using a dry developer containing a toner, for example, using a developing device including an agitator for frictionally stir and charging the toner, and a rotatable magnet roller. Specifically, in the developing device, for example, the toner and the carrier are mixed and agitated, and the toner is charged by friction at that time, and held on the surface of the rotating magnet roller, thereby forming a magnetic brush. Since the magnet roller is disposed near the photoreceptor, a part of the toner constituting the magnetic brush formed on the surface of the magnet roller moves to the surface of the photoreceptor by the electric attraction force. As a result, the electrostatic charge image is developed by the toner to form a toner image on the surface of the photoreceptor.

<Transfer Step>

In the transfer step, the toner image is transferred to a transfer material. The transfer of the toner image to the transfer material is performed by releasing and charging the toner image to the transfer material. As the transfer device, for example, a corona transfer device by corona discharge, a transfer belt, or a transfer roller may be used. The transfer step may be performed by, for example, a mode in which a toner image is primarily transferred onto an intermediate transfer member using an intermediate transfer member and then the toner image is secondarily transferred onto a transfer material, or a mode in which a toner image formed on a photosensitive member is directly transferred onto a transfer material. The transfer material is not particularly limited, and examples thereof include plain paper from thin paper to cardboard, a coated printing paper such as a high quality paper, an art paper or a coated paper, a commercially available Japanese paper or a postcard paper, a plastic film for OHP, and a cloth.

<Fixing Step>

The fixing step is a step of fixing the transfer material to which the toner image has been transferred by, for example, nip conveyance to a fixing nip portion provided between a heated fixing rotating body and a pressure member to thermally fix the transfer material.

<Cleaning Step>

After the transfer step, there is the toner on the photoreceptor that have not been used for image formation or have remained untransferred. In the cleaning step, for example, the above-described toner is removed by a blade which is provided so that its tip abuts on the photoreceptor and which scrapes the surface of the photoreceptor.

In the present invention, as the photoreceptor and the toner used in such an image forming method, the photoreceptor and the toner having the above technical features are used in combination. Hereinafter, the photoreceptor and the toner will be described in detail.

[Electrophotographic Photoreceptor]

In an outermost layer of the photoreceptor, a universal hardness value (HU) of the photoreceptor is 170 N/mm² or more, and an elastic deformation ratio (HU) of the photoreceptor is 40% or more when a Vickers indenter is used in an environment at a temperature of 25° C. and a relative humidity of 50% and the photoreceptor is pushed by a load of up to 2 mN. Further, the photoreceptor has a photosensitive layer. The photosensitive layer has both a function of generating charge by absorbing light and a function of transporting charge.

As a layer structure of the photosensitive layer, a single layer structure containing a charge generating material and a charge transport material may be used, or a laminated structure of a charge generating layer containing a charge generating material and a charge transport layer containing a charge transport material may be used. An intermediate layer may be provided between the conductive support and the photosensitive layer as necessary. The photosensitive layer is not particularly limited in its layer configuration, and specific layer configurations including a protective layer and an intermediate layer include, for example, those shown below.

(1) Layer structure in which a photosensitive layer composed of a charge generating layer and a charge transport layer is laminated on a conductive support

(2) Layer structure in which a photosensitive layer composed of a charge generating layer and a charge transport layer, and a surface protective layer are sequentially laminated on a conductive support

(3) Layer structure in which a single photosensitive layer containing a charge transport material and a charge generating material, and a surface protective layer are sequentially laminated on a conductive support

(4) Layer structure in which an intermediate layer, a photosensitive layer composed of a charge generating layer and a charge transport layer, and a surface protective layer are sequentially laminated on a conductive support

(5) Layer structure in which an intermediate layer, a single photosensitive layer containing a charge transport material and a charge generating material, and a surface protective layer are sequentially laminated on a conductive support

The photoreceptor according to the present invention may be any of the layer configurations of (1) to (5) described above, and among these, those having the layer configuration of (4) described above are particularly preferred.

In the cases (2) to (5) above, the outermost layer is the surface protective layer, and in the case (1) above, the outermost layer is the charge transport layer.

FIG. 2 is a cross-sectional view showing an example of the layer structure of the photoreceptor according to the present invention. As shown in FIG. 2, the photoreceptor 200 is formed by sequentially stacking an intermediate layer 202, a photosensitive layer 203, and a surface protective layer 204 on a conductive support 201. The photosensitive layer 203 is composed of a charge generating layer 203a and a charge transport layer 203b. Further, it is preferable that the surface protective layer 204 contains metal oxide particles PS.

The photoreceptor according to the present invention is an organic photoreceptor, and the organic photoreceptor means an electrophotographic photoreceptor in which at least one of a charge generating function and a charge transport function essential to the configuration of the electrophotographic photoreceptor is expressed by an organic compound, and includes a photoreceptor composed of a known organic charge generating material or organic charge transport material, and a photoreceptor in which the charge generating function and the charge transport function are configured by a polymer complex.

<Surface Protective Layer>

It is preferable that the surface protective layer contains a cured product of a composition containing a radically polymerizable compound for a binder, a charge transport material, and a photopolymerization initiator. Further, the surface protective layer according to the present invention may further contain inorganic particles.

[1] Radically Polymerizable Compound for a Binder

As the radically polymerizable compound for a binder, a monomer having a radically polymerizable functional group and constituting a binder resin of a photoreceptor by polymerization (curing) by a radical polymerization initiator is used. Examples of the binder resin include polystyrene and polyacrylate. Note that the radically polymerizable compound for a binder according to the present invention does not include the charge transport material according to the present invention.

As the radically polymerizable compound for a binder, a crosslinkable polymerizable compound is preferably used from the viewpoint of maintaining high durability. Specific examples of the crosslinkable polymerizable compound include a polymerizable compound having 2 or more radically polymerizable functional groups (hereinafter, also referred to as a “polyfunctional radically polymerizable compound”).

In addition to the above polyfunctional radically polymerizable compound, a compound having 1 radically polymerizable functional group (hereinafter, also referred to as a “monofunctional radically polymerizable compound”) may be used in combination. When a monofunctional radically polymerizable compound is used, the ratio thereof is preferably 20% by mass or less based on the total amount of the monomers for forming the binder resin. Examples of the radically polymerizable functional group include a vinyl group, an acryloyl group, a methacryloyl group, an acryloyloxy group, and a methacryloyloxy group.

As the polyfunctional radically polymerizable compound, acrylic monomers having two or more acryloyl groups (CH₂=CHCO—) or methacryloyl groups (CH₂=CCH₃CO—) as radically polymerizable functional groups or oligomers thereof are particularly preferable because they may be cured with a small amount of light or in a short period of time. Therefore, an acrylic resin formed of an acrylic monomer or an oligomer thereof is preferable as the resin.

In the present invention, the polyfunctional radically polymerizable compound may be used alone or as a mixture of a plurality of kinds. Further, these polyfunctional radically polymerizable compounds may be used as monomers, but may be oligomerized and used.

Specific examples of the polyfunctional radically polymerizable compound will be described below.

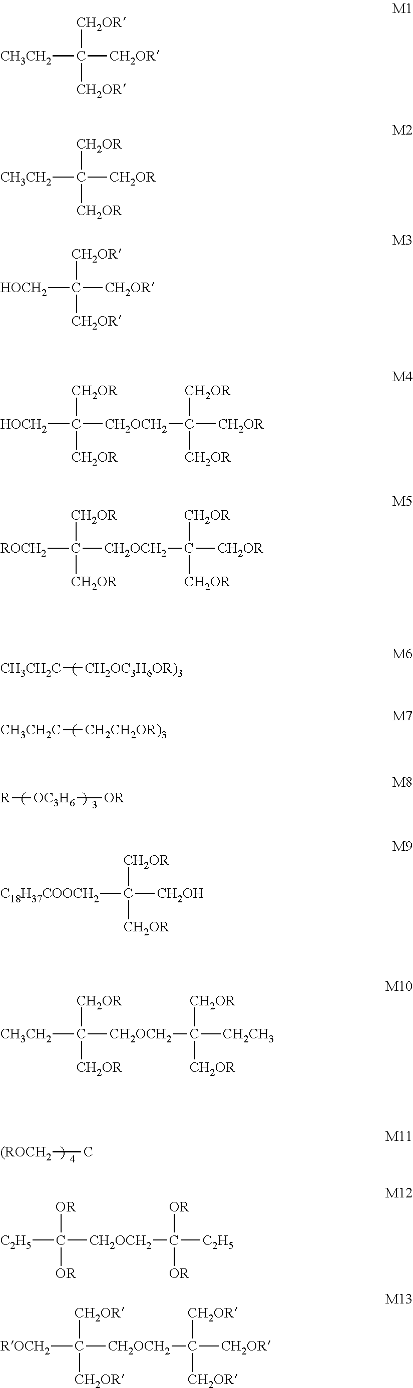

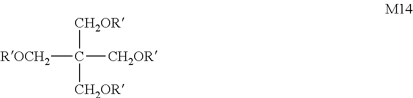

In the above chemical formulae showing the exemplified compounds M1 to M14, R represents an acryloyl group (CH₂=CHCO—) and R′ represents a methacryloyl group (CH₂=CCH₃CO—).

[2] Charge Transport Material

As the charge transport material, it is a material having a charge transport property for transporting a charge carrier in a protective layer, and is a material capable of adjusting an electric resistance of the protective layer. For example, N, N-dialkyaniline compounds, diarylamine compounds, amine compounds such as triarylamine compounds, pyrazoline compounds, carbazole compounds, imidazole compounds, triazole compounds, oxazole compounds, styryl compounds, and stilbene compounds may be used.

Although the charge transport material may be appropriately selected from known compounds, the protective layer preferably has a polymerizable reactive group (radically polymerizable reactive group) from the viewpoint of scratch resistance, charge injection characteristics, and low transfer memory occurrence probability, and examples of the radically polymerizable reactive group include a vinyl group, an acryloyl group, and a methacryloyl group. Further, as such a charge transport material, for example, it is preferable to have a structure represented by the following Formula (1).

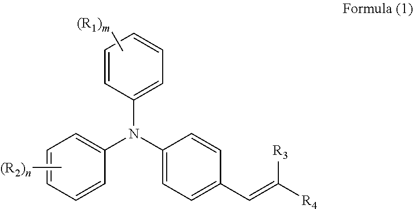

In the above Formula (1), R₁ and R₂ each independently represent a substituent, and at least one of R₁ and R₂ represents a methacryloyloxy group or an acryloyloxy group connected by an alkylene group having 1 to 5 carbon atoms. m and n each independently represent an integer of 0 to 5. However, both m and n do not represent 0. R₃ and R₄ each independently represent a hydrogen atom or a substituted or unsubstituted aromatic ring group.

In Formula (1), as substituents represented by R₁ and R₂, for example, alkyl groups (e.g., methyl group, ethyl group, propyl group, isopropyl group, (t)butyl group, pentyl group, hexyl group, octyl group, dodecyl group, tridecyl group, tetradecyl group, pentadecyl group, and benzyl group), alkoxy groups (e.g., methoxy group, ethoxy group, propyloxy group, butoxy group, pentyloxy group, hexyloxy group, methacryloyloxy group, cycloalkyl group, and cyclohenyl group), alkenyl groups (e.g., vinyl group and allyl group), alkynyl groups (e.g., propargyl group) may be mentioned. Among them, for example, an alkyl group, an alkoxy group, an acryloyloxy group, and a methacryloyloxy group are preferred. Incidentally, these substituents may be further substituted by the substituents described above, also, they may be fused to each other to further form a ring. In addition, specific examples in parentheses in these substituents are not limited thereto. When m in the Formula (1) represents an integer of 2 to 5, the substituents represented by R₁ may be different from each other, and the same applies to the case where n in the Formula (1) represents an integer of 2 to 5.

In Formula (1), at least one of R₁ and R₂ represents a methacryloyloxy group or an acryloyloxy group linked by an alkylene group having 1 to 5 carbon atoms, and it is preferable to represent a methacryloyloxy group or an acryloyloxy group linked by a methylene group.

In Formula (1), examples of the aromatic ring group represented by R₃ and R₄ include: aromatic hydrocarbon ring groups (also referred to as aryl groups) such as phenyl group, p-chlorophenyl group, mesityl group, tolyl group, xylyl group, naphthyl group, anthryl group, azlrenyl group, acenaphthenyl group, fluorenyl group, phenanthryl group, indenyl group, pyrenyl group, and biphenyl group; and aromatic heterocyclic groups such as pyridyl group, pyrimidinyl group, furyl group, pyrrolyl group, imidazolyl group, benzoimidazolyl group, pyrazolyl group, pyrazinyl group, triazolyl group (e.g., 1,2,4-triazole-1-yl group and 1,2,3-triazole-1-yl group), oxazolyl group, benzoxazolyl group, thiazolyl group, isooxazolyl group, isothiazolyl group, frazayl group, thienyl group, quinolyl group, benzofuryl group, dibenzofuryl group, benzothienyl group, dibenzothienyl group, indolyl group, carbazolyl group, carbolinyl group, diazacarbazolyl group (indicating one in which one of the carbon atoms constituting the carboline ring of the carbolinyl group is replaced with a nitrogen atom), quinoxalinyl group, pyridazinyl group, triazinyl group, quinazolinyl group, and phthalazinyl group. These groups may be further substituted by substituents represented by the above R₁ and R₂, or they may be fused with each other to form a ring.

Further, it is more preferable that the compound having a structure represented by the above Formula (1) is a compound having a structure represented by the following Formula (2).

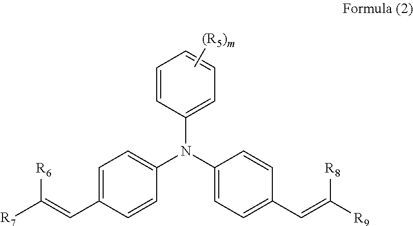

In the above Formula (2), R₅ represents a substituent, and at least one of them represents a methacryloyloxy group or an acryloyloxy group linked by an alkylene group having 1 to 5 carbon atoms. m represents an integer of 1 and 5. R₆ to R₉ each independently represent a hydrogen atom or a substituted or unsubstituted aromatic ring group.

In Formula (2), the substituent represented by R₅ includes the same substituent represented by R₁ and R₂ in the above Formula (1). In Formula (2), as the substituted or unsubstituted aromatic ring group represented by R₆ to R₉, the same as the substituted or unsubstituted aromatic ring group represented by R₃ and R₄ in the above Formula (1) may be cited.

Specific examples of the compound having the structure represented by the above Formula (1) or (2) are shown below, but are not limited thereto.

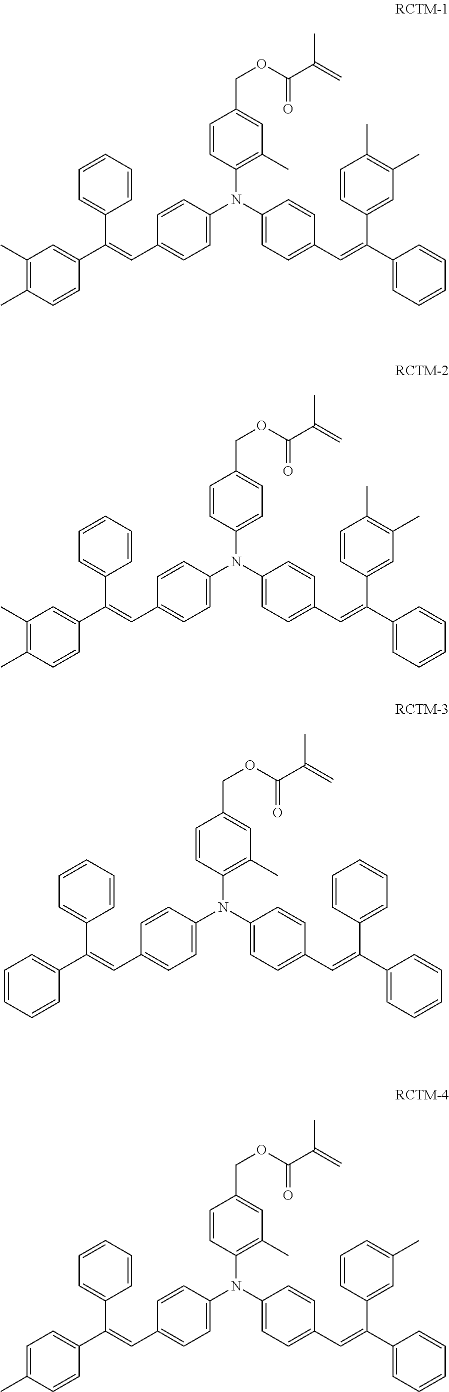 [SMILES: C=C(C)C(=O)OCc1ccc(N(c2ccc(/C=C(/c3ccccc3)c3ccc(C)c(C)c3)cc2)c2ccc(/C=C(\c3ccccc3)c3ccc(C)c(C)c3)cc2)c(C)c1 ; C=C(C)C(=O)OCc1ccc(N(c2ccc(/C=C(/c3ccccc3)c3ccc(C)c(C)c3)cc2)c2ccc(/C=C(\c3ccccc3)c3ccc(C)c(C)c3)cc2)cc1 ; C=C(C)C(=O)OCc1ccc(N(c2ccc(C=C(c3ccccc3)c3ccccc3)cc2)c2ccc(C=C(c3ccccc3)c3ccccc3)cc2)c(C)c1 ; C=C(C)C(=O)OCc1ccc(N(c2ccc(/C=C(/c3ccccc3)c3cccc(C)c3)cc2)c2ccc(/C=C(\c3ccccc3)c3ccc(C)cc3)cc2)c(C)c1]

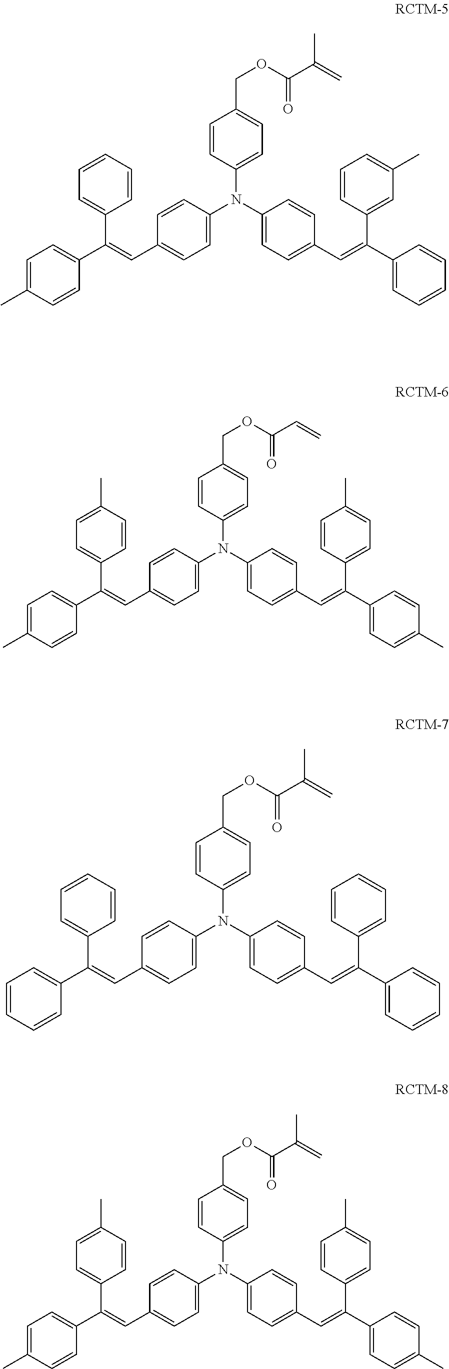

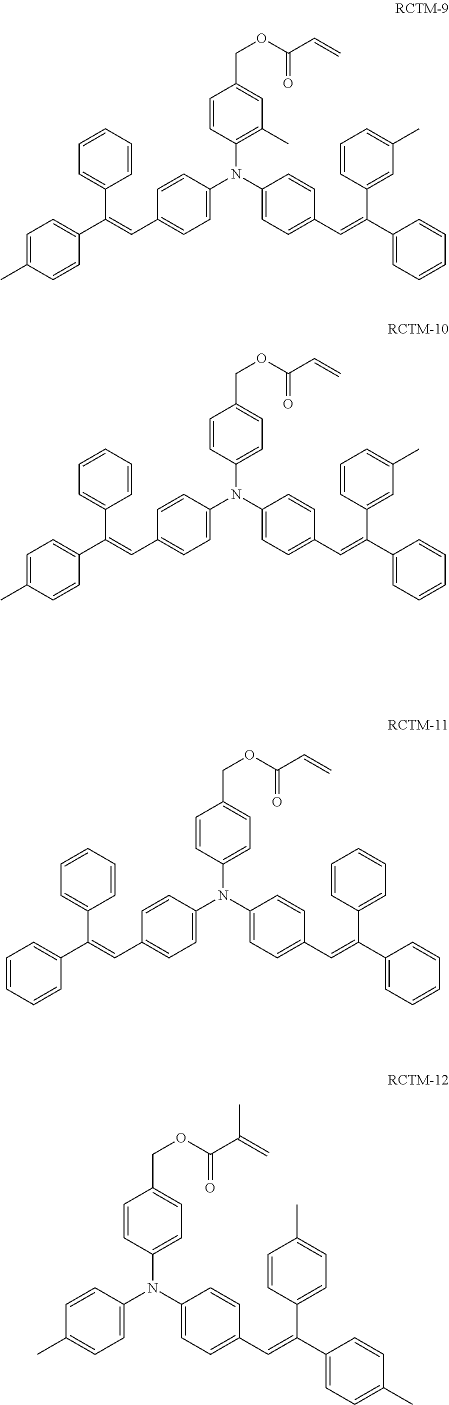

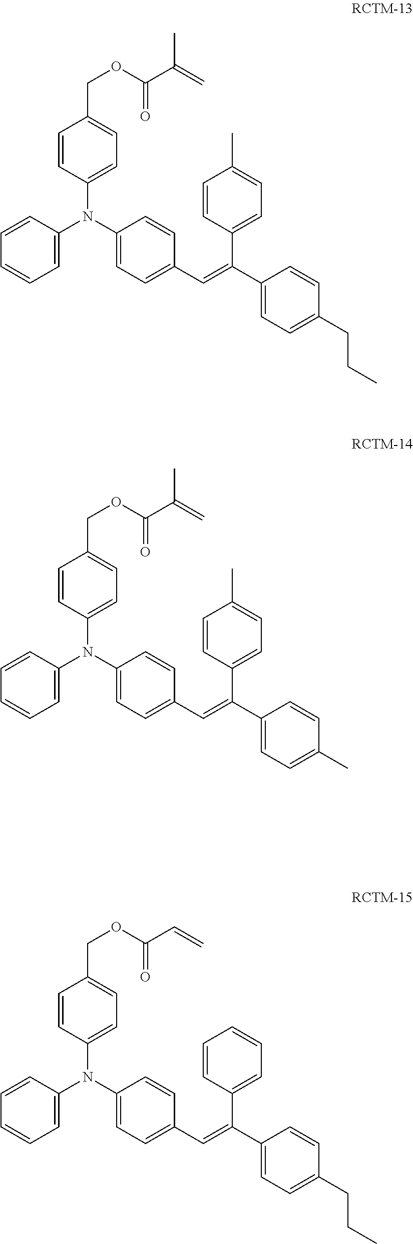 [SMILES: C=C(C)C(=O)OCc1ccc(N(c2ccccc2)c2ccc(/C=C(\c3ccc(C)cc3)c3ccc(CCC)cc3)cc2)cc1 ; C=C(C)C(=O)OCc1ccc(N(c2ccccc2)c2ccc(C=C(c3ccc(C)cc3)c3ccc(C)cc3)cc2)cc1 ; C=CC(=O)OCc1ccc(N(c2ccccc2)c2ccc(/C=C(\c3ccccc3)c3ccc(CCC)cc3)cc2)cc1]

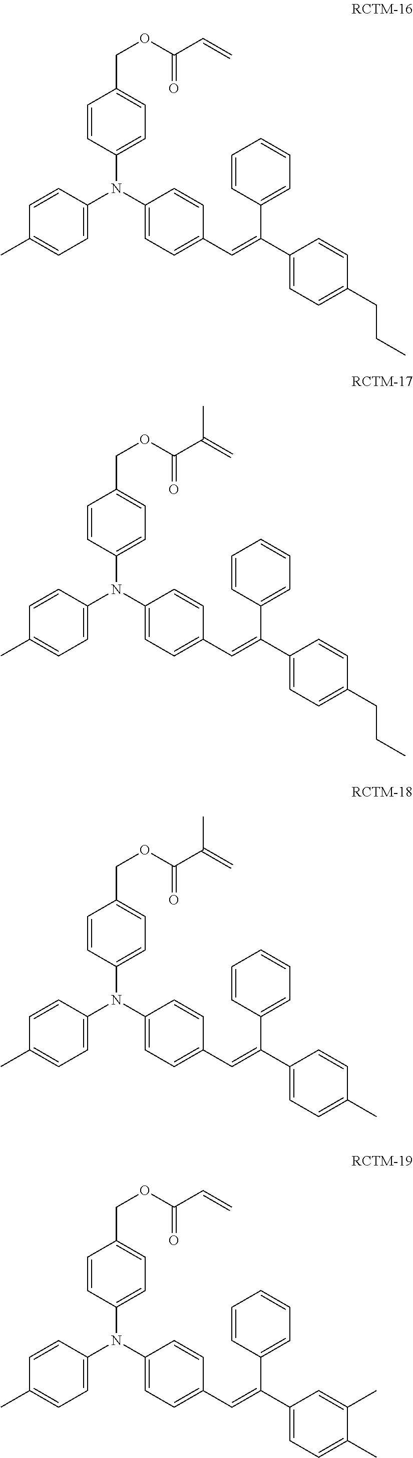

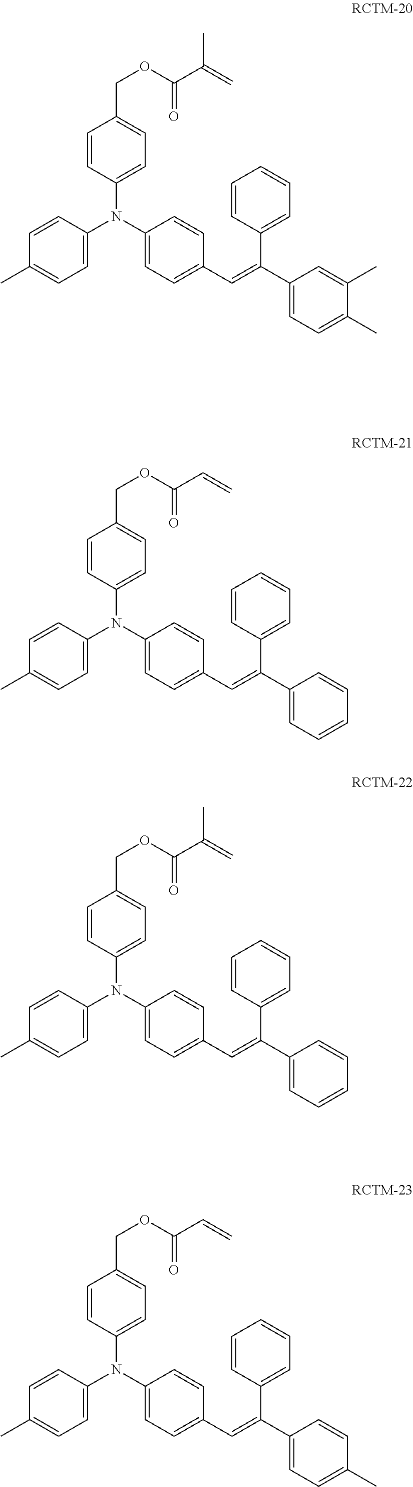

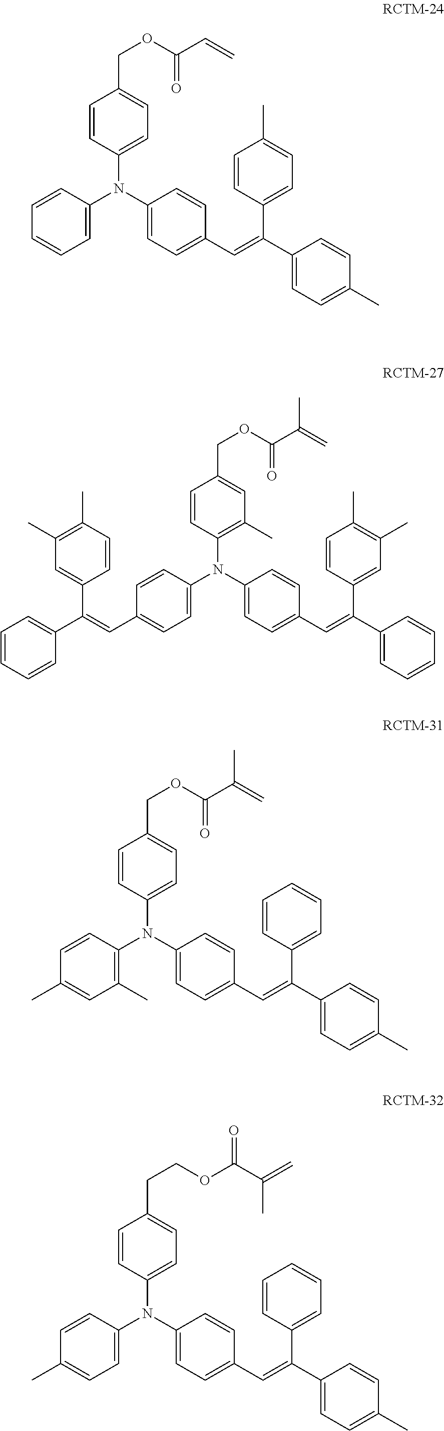

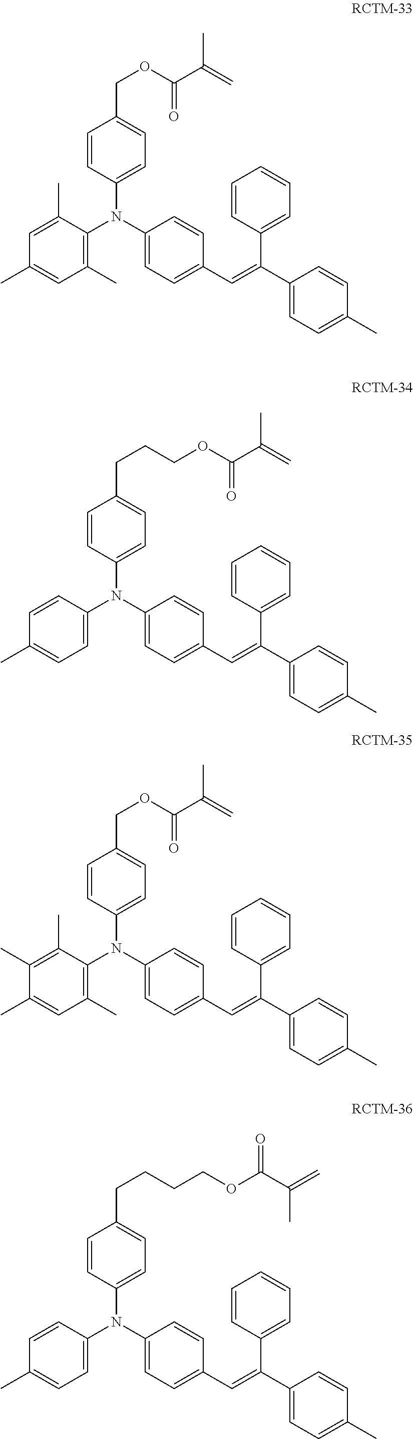

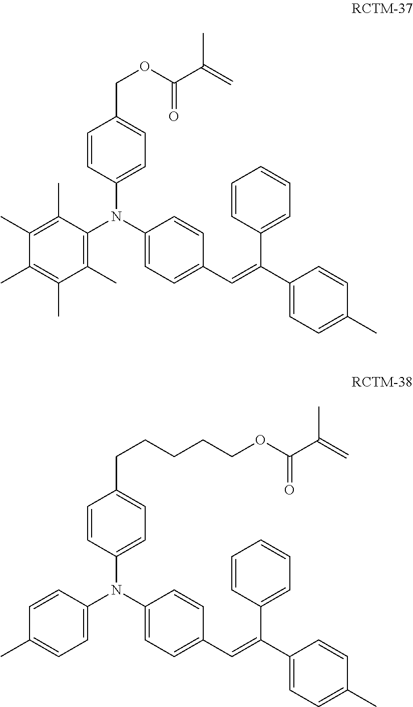

Further, specific examples of the compound which is a charge transport material and does not have the structure represented by the above Formula (1) or (2) are shown below, but are not limited thereto.

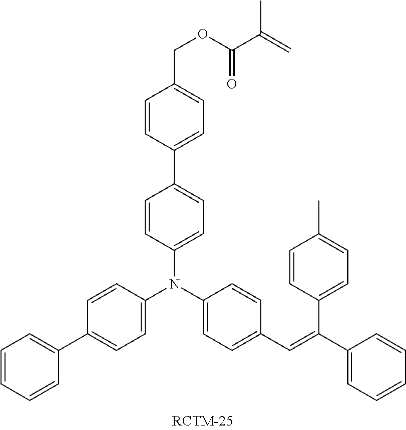 [SMILES: C=C(C)C(=O)OCc1ccc(-c2ccc(N(c3ccc(/C=C(/c4ccccc4)c4ccc(C)cc4)cc3)c3ccc(-c4ccccc4)cc3)cc2)cc1]

| Compound | Structure |
|---|---|
| CTM-1 | 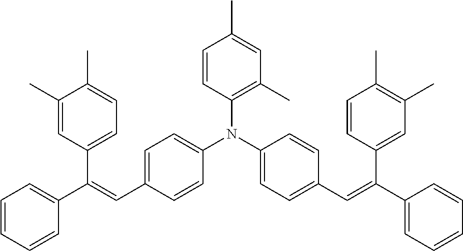 [SMILES: Cc1ccc(N(c2ccc(/C=C(/c3ccccc3)c3ccc(C)c(C)c3)cc2)c2ccc(/C=C(/c3ccccc3)c3ccc(C)c(C)c3)cc2)c(C)c1] |
| CTM-2 | 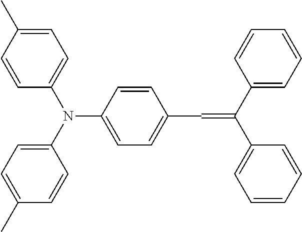 [SMILES: Cc1ccc(N(c2ccc(C)cc2)c2ccc(C=C(c3ccccc3)c3ccccc3)cc2)cc1] |
| CTM-3 | 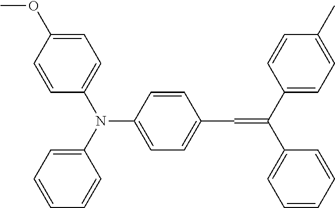 |
| CTM-4 | 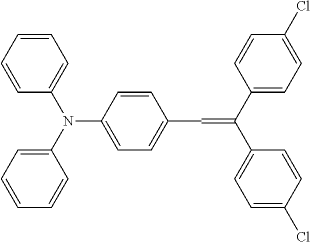 [SMILES: Clc1ccc(C(=Cc2ccc(N(c3ccccc3)c3ccccc3)cc2)c2ccc(Cl)cc2)cc1] |
| CTM-5 | 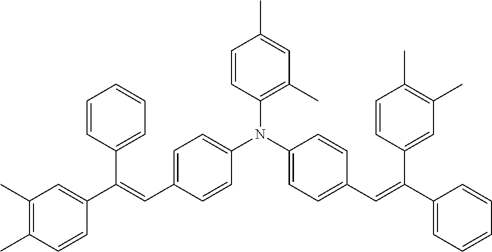 [SMILES: Cc1ccc(N(c2ccc(/C=C(/c3ccccc3)c3ccc(C)c(C)c3)cc2)c2ccc(/C=C(\c3ccccc3)c3ccc(C)c(C)c3)cc2)c(C)c1] |
| CTM-141 | 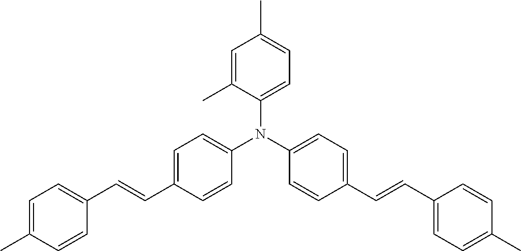 |
| CTM-143 | 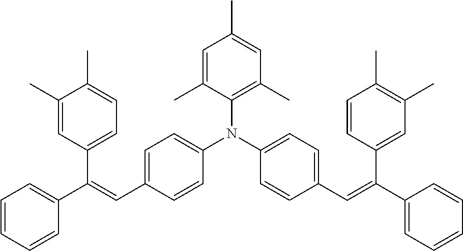 [SMILES: Cc1cc(C)c(N(c2ccc(/C=C(/c3ccccc3)c3ccc(C)c(C)c3)cc2)c2ccc(/C=C(/c3ccccc3)c3ccc(C)c(C)c3)cc2)c(C)c1] |
| CTM-144 | 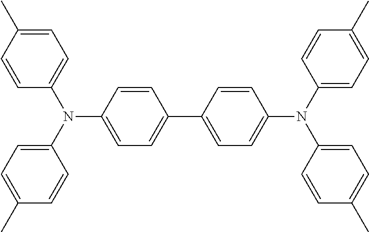 [SMILES: Cc1ccc(N(c2ccc(C)cc2)c2ccc(-c3ccc(N(c4ccc(C)cc4)c4ccc(C)cc4)cc3)cc2)cc1] |
| CTM-145 | 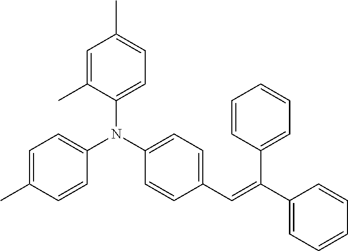 [SMILES: Cc1ccc(N(c2ccc(C=C(c3ccccc3)c3ccccc3)cc2)c2ccc(C)cc2C)cc1] |
| CTM-146 | 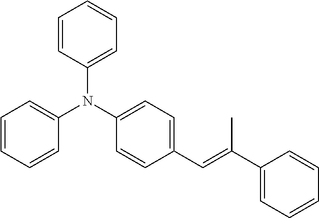 [SMILES: C/C(=C\c1ccc(N(c2ccccc2)c2ccccc2)cc1)c1ccccc1] |
| CTM-147 | 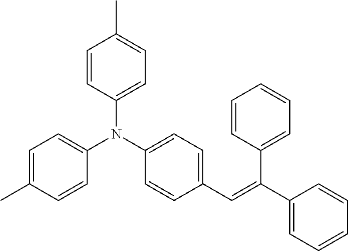 [SMILES: Cc1ccc(N(c2ccc(C)cc2)c2ccc(C=C(c3ccccc3)c3ccccc3)cc2)cc1] |

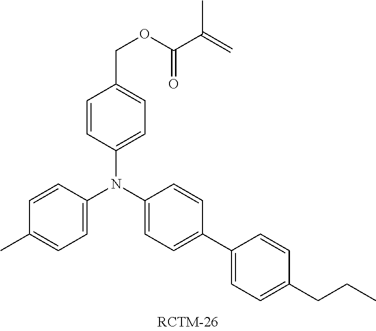 [SMILES: C=C(C)C(=O)OCc1ccc(N(c2ccc(C)cc2)c2ccc(-c3ccc(CCC)cc3)cc2)cc1]

These charge transport materials may be synthesized by a known synthesis method, for example, the method described in JP-A 2006-143720. Note that the molecular weight of these charge transport materials was set to be two significant figures after the decimal point.

Further, as other charge transport materials which may be contained in the protective layer, a charge transport material contained in a protective layer of a conventionally known electrophotographic photoreceptor may also be used.

The addition ratio of the charge transport material is preferably within a range of 10 to 100 parts by mass, and more preferably within a range of 20 to 60 parts by mass, per 100 parts by mass of the radically polymerizable compound for a binder.

[3] Photopolymerization Initiator

The photopolymerization initiator according to the present invention is not particularly limited, but from the viewpoint of more reliably suppressing side effects such as decrease in memory resistance, for example, a single molecule photopolymerization initiator having an acylphosphine oxide structure or an O-acyloxime structure is preferred. These may be used alone or in combination of a plurality of types. Note that, in the present invention, a single molecule photopolymerization initiator refers to one in which one molecule functions as a photopolymerization initiator alone, and a bimolecular photopolymerization initiator refers to one in which two or more molecules together function as a photopolymerization initiator only when combined.

Specific examples of the photopolymerization initiator having an acylphosphine oxide structure are shown below.

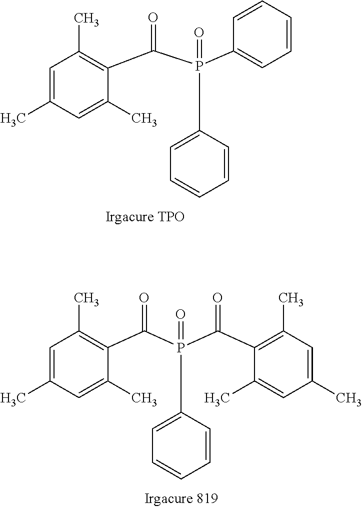

Of the two of the above Irgacure TPO (manufactured by BASF Japan Co., Ltd.) and Irgacure 819 (manufactured by BASF Japan Co., Ltd.), Irgacure 819 is preferred.

Further, examples of the photopolymerization initiator having an O-acyloxime structure include Irgacure OXE02 (manufactured by (BASF Japan Co., Ltd.), and compounds shown below.

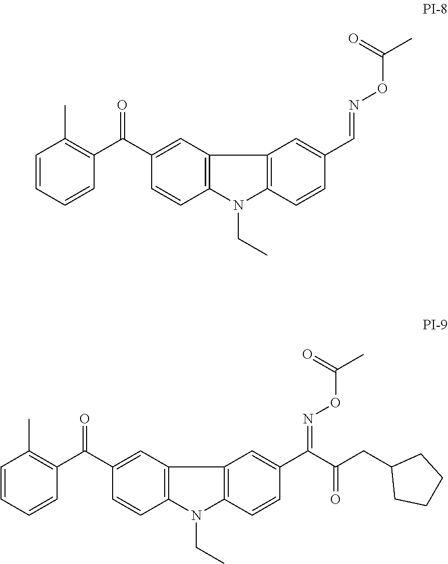 [SMILES: CCn1c2ccc(/C=N/OC(C)=O)cc2c2cc(C(=O)c3ccccc3C)ccc21 ; CCn1c2ccc(C(=O)c3ccccc3C)cc2c2cc(/C(=N/OC(C)=O)C(=O)CC3CCCC3)ccc21]

In addition, in the present invention, as the photopolymerization initiator having an O-acyloxime structure, a photopolymerization initiator having a structure represented by the following Formula (3) is preferred.

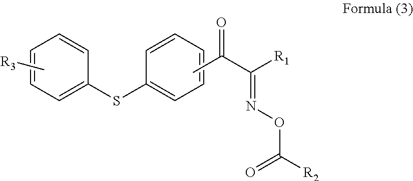

In Formula (3), R₁ and R₂ each independently represent a hydrogen atom, an alkyl group having 1 to 6 carbon atoms which may have a substituent, a cycloalkyl group having 3 to 6 carbon atoms which may have a substituent, or an aryl group which may have a substituent. R₃ represents a hydrogen atom, an alkyl group having 1 to 6 carbon atoms which may have a substituent, an alkoxy group having 1 to 6 carbon atoms which may have a substituent, an aryl group which may have a substituent, a halogen atom, a cyano group, a nitro group, a hydroxy group, or a carbonyl group which may have a substituent. Specific examples of the alkyl group, the cycloalkyl group, the aryl group, and the alkoxy group in Formula (3) are the same as the alkyl group, the cycloalkyl group, and the alkoxy group listed as substituents represented by R₁ and R₂ in Formula (1) described above, and the aromatic hydrocarbon ring group represented by R₃ and R₄ in Formula (1) described above. Specific examples of the substituent in Formula (3) are the same as the substituent represented by R₁ and R₂ in Formula (1).

Specific examples of the compound having the structure represented by the above Formula (3) are shown below.

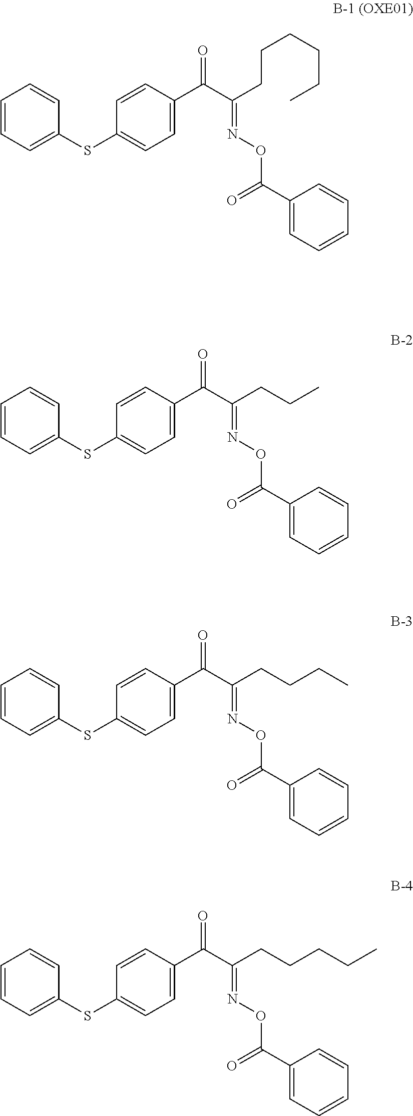 [SMILES: CCCCCC/C(=N\OC(=O)c1ccccc1)C(=O)c1ccc(Sc2ccccc2)cc1 ; CCC/C(=N\OC(=O)c1ccccc1)C(=O)c1ccc(Sc2ccccc2)cc1 ; CCCC/C(=N\OC(=O)c1ccccc1)C(=O)c1ccc(Sc2ccccc2)cc1 ; CCCCC/C(=N\OC(=O)c1ccccc1)C(=O)c1ccc(Sc2ccccc2)cc1]

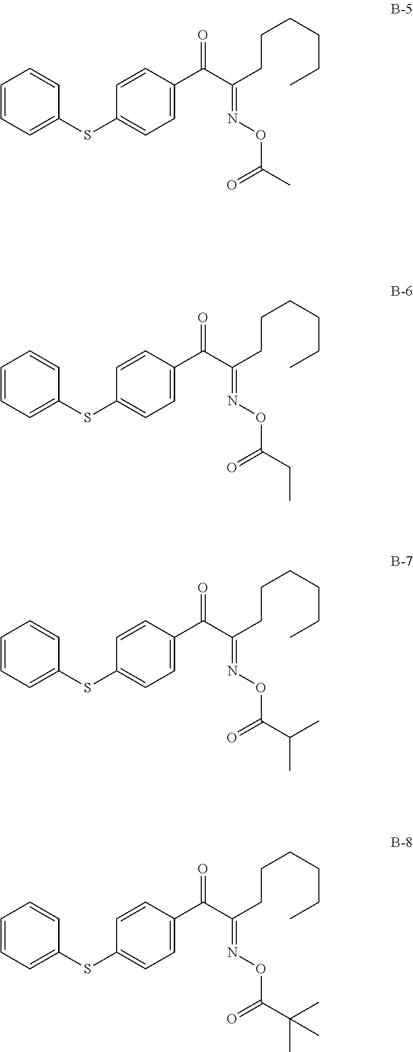 [SMILES: CCCCCC/C(=N\OC(C)=O)C(=O)c1ccc(Sc2ccccc2)cc1 ; CCCCCC/C(=N\OC(=O)CC)C(=O)c1ccc(Sc2ccccc2)cc1 ; CCCCCC/C(=N\OC(=O)C(C)C)C(=O)c1ccc(Sc2ccccc2)cc1 ; CCCCCC/C(=N\OC(=O)C(C)(C)C)C(=O)c1ccc(Sc2ccccc2)cc1]

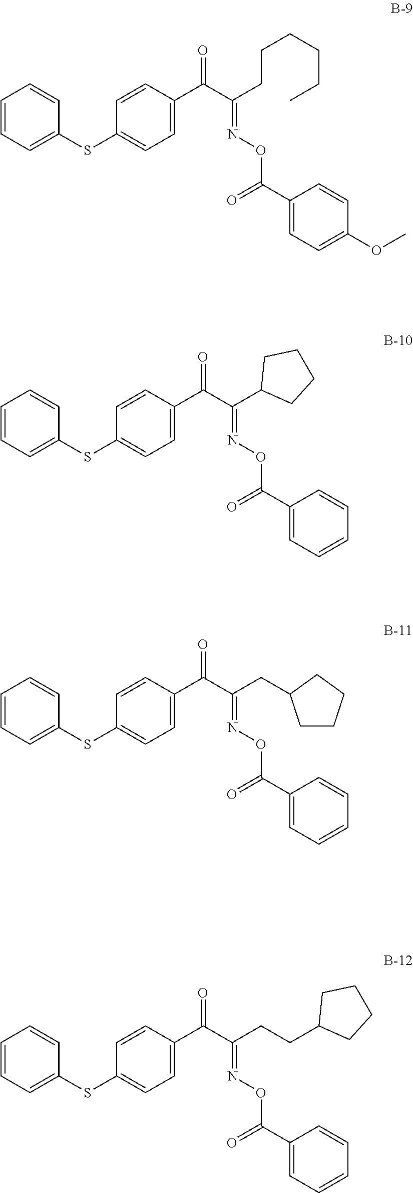 [SMILES: CCCCCC/C(=N\OC(=O)c1ccc(OC)cc1)C(=O)c1ccc(Sc2ccccc2)cc1 ; O=C(O/N=C(/C(=O)c1ccc(Sc2ccccc2)cc1)C1CCCC1)c1ccccc1 ; O=C(O/N=C(\CC1CCCC1)C(=O)c1ccc(Sc2ccccc2)cc1)c1ccccc1 ; O=C(O/N=C(\CCC1CCCC1)C(=O)c1ccc(Sc2ccccc2)cc1)c1ccccc1]

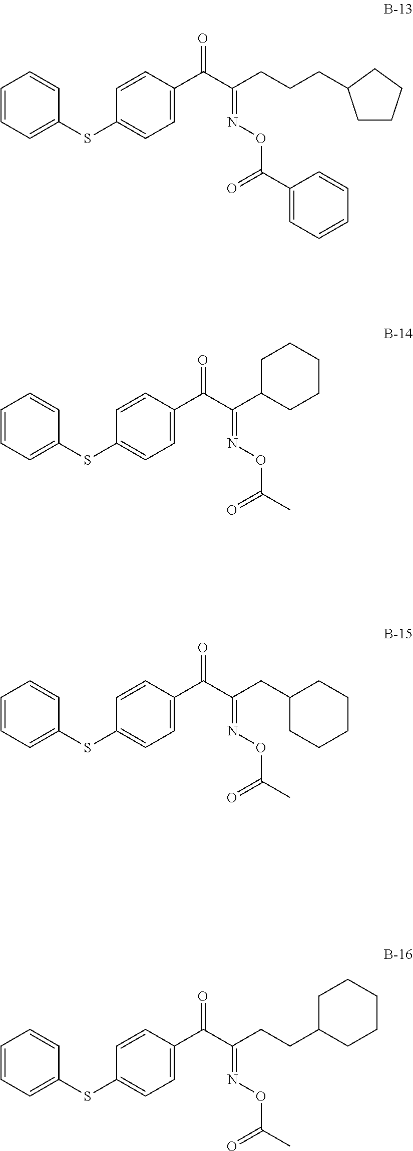 [SMILES: O=C(O/N=C(\CCCC1CCCC1)C(=O)c1ccc(Sc2ccccc2)cc1)c1ccccc1 ; CC(=O)O/N=C(/C(=O)c1ccc(Sc2ccccc2)cc1)C1CCCCC1 ; CC(=O)O/N=C(\CC1CCCCC1)C(=O)c1ccc(Sc2ccccc2)cc1 ; CC(=O)O/N=C(\CCC1CCCCC1)C(=O)c1ccc(Sc2ccccc2)cc1]

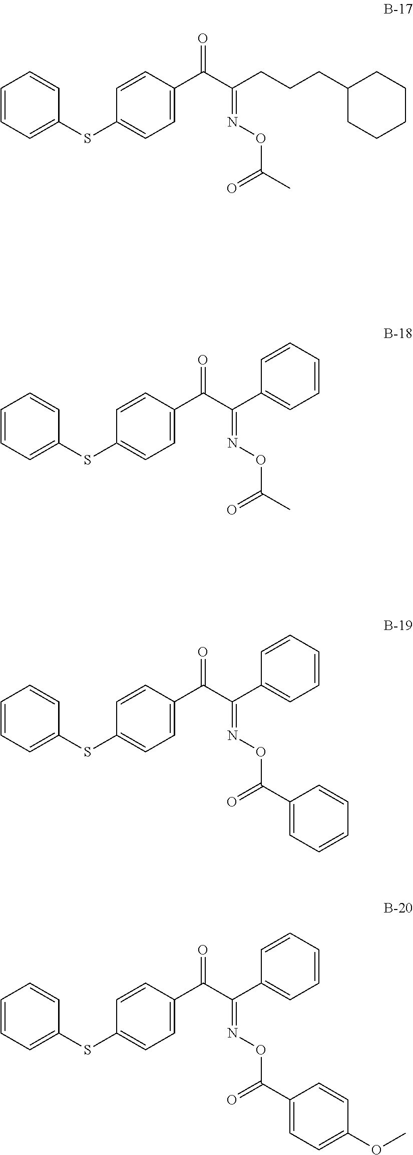 [SMILES: CC(=O)O/N=C(\CCCC1CCCCC1)C(=O)c1ccc(Sc2ccccc2)cc1 ; CC(=O)O/N=C(/C(=O)c1ccc(Sc2ccccc2)cc1)c1ccccc1 ; O=C(O/N=C(/C(=O)c1ccc(Sc2ccccc2)cc1)c1ccccc1)c1ccccc1 ; COc1ccc(C(=O)O/N=C(/C(=O)c2ccc(Sc3ccccc3)cc2)c2ccccc2)cc1]

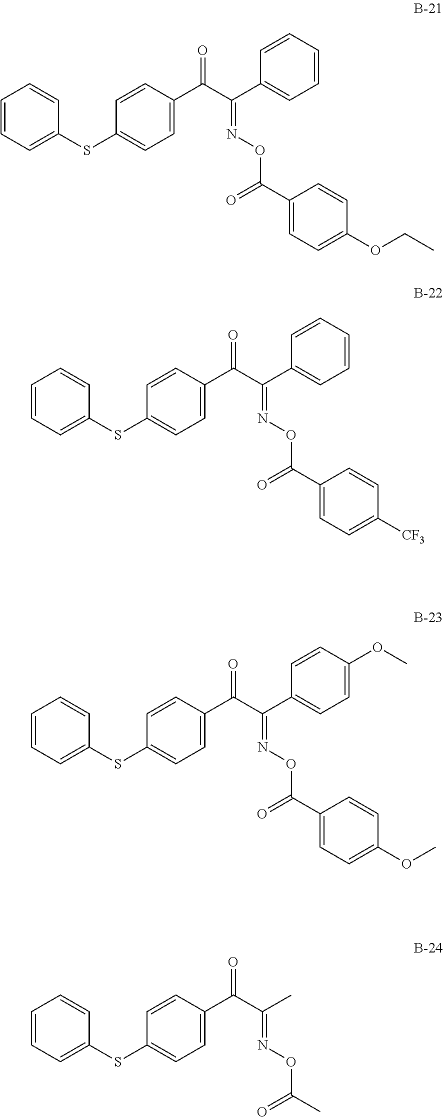 [SMILES: CCOc1ccc(C(=O)O/N=C(/C(=O)c2ccc(Sc3ccccc3)cc2)c2ccccc2)cc1 ; O=C(O/N=C(/C(=O)c1ccc(Sc2ccccc2)cc1)c1ccccc1)c1ccc(C(F)(F)F)cc1 ; COc1ccc(C(=O)O/N=C(/C(=O)c2ccc(Sc3ccccc3)cc2)c2ccc(OC)cc2)cc1 ; CC(=O)O/N=C(\C)C(=O)c1ccc(Sc2ccccc2)cc1]

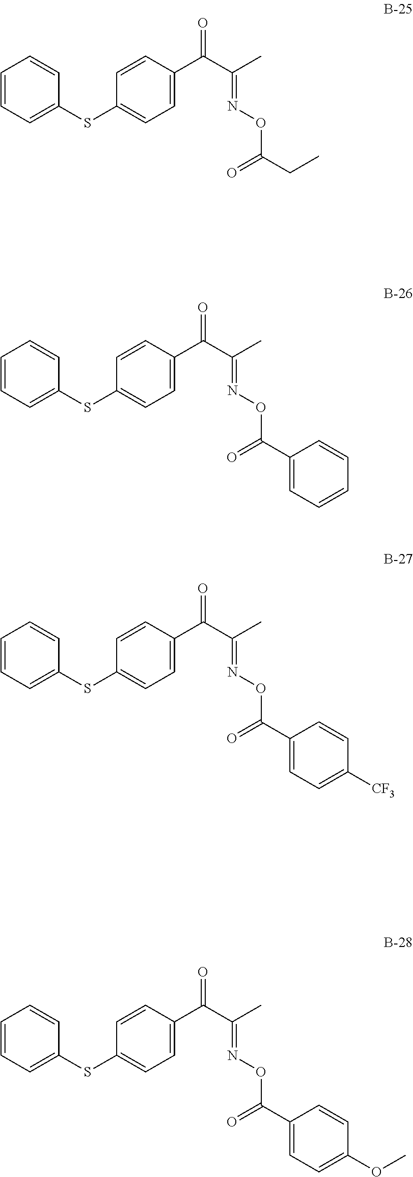 [SMILES: CCC(=O)O/N=C(\C)C(=O)c1ccc(Sc2ccccc2)cc1 ; C/C(=N\OC(=O)c1ccccc1)C(=O)c1ccc(Sc2ccccc2)cc1 ; C/C(=N\OC(=O)c1ccc(C(F)(F)F)cc1)C(=O)c1ccc(Sc2ccccc2)cc1 ; COc1ccc(C(=O)O/N=C(\C)C(=O)c2ccc(Sc3ccccc3)cc2)cc1]

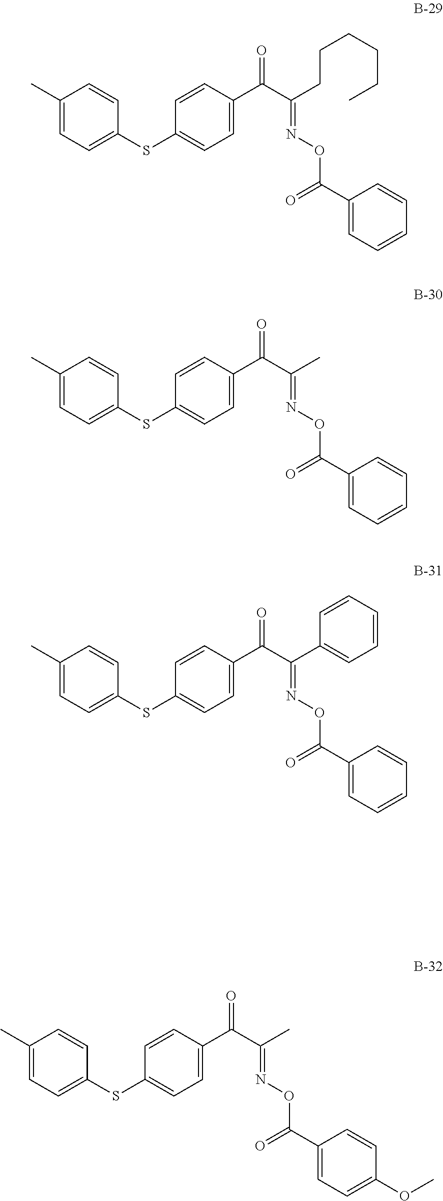

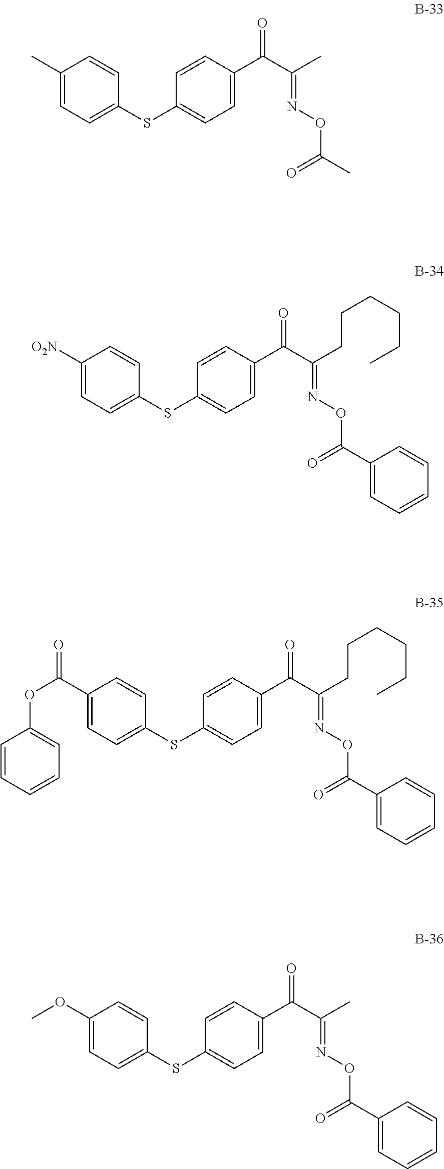

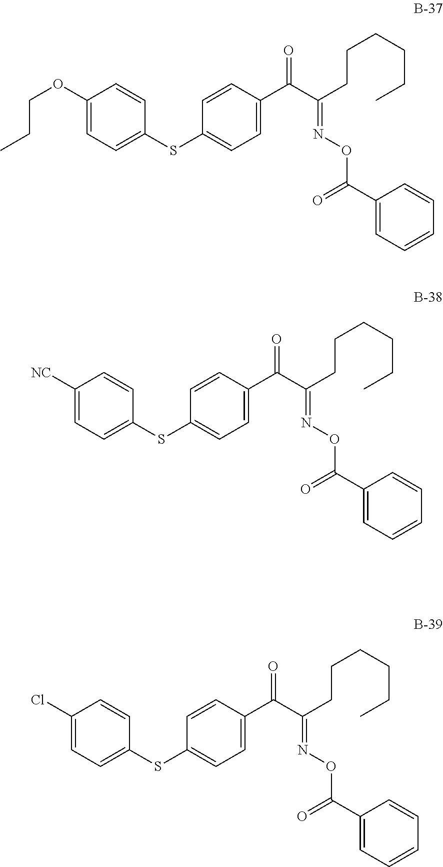 [SMILES: CCCCCC/C(=N\OC(=O)c1ccccc1)C(=O)c1ccc(Sc2ccc(OCCC)cc2)cc1 ; CCCCCC/C(=N\OC(=O)c1ccccc1)C(=O)c1ccc(Sc2ccc(C#N)cc2)cc1 ; CCCCCC/C(=N\OC(=O)c1ccccc1)C(=O)c1ccc(Sc2ccc(Cl)cc2)cc1]

As a commercially available product of a photopolymerization initiator having an O-acyloxime structure, for example, in addition to the above exemplified compound B-1 (Irgacure OXE01) (manufactured by BASF Japan Co., Ltd.), PBG-305 or PBG-329 which is an O-acyloxime initiator having a disulfide structure in a compound (all of which are manufactured by Changzhou Strong Electronic New Materials Co., Ltd.) may be mentioned.

Further, the photopolymerization initiator according to the present invention is not limited to the above-described one molecule photopolymerization initiator, and a bimolecular photopolymerization initiator may be used. Examples of the bimolecular photopolymerization initiator include a combination of a compound having a hexaarylbisimidazole structure and a thiol compound.

Specific examples of the compound having a hexaarylbisimidazole structure used in a photopolymerization initiator of a bimolecular system are shown below.

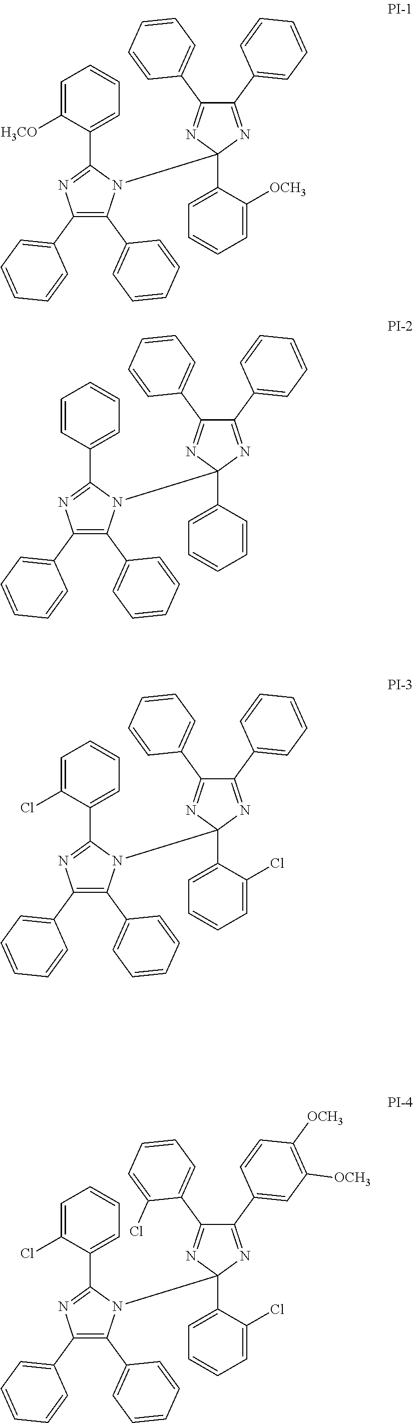

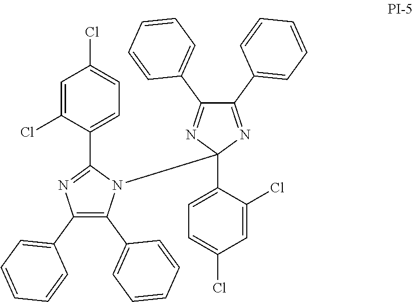 [SMILES: Clc1ccc(-c2nc(-c3ccccc3)c(-c3ccccc3)n2C2(c3ccc(Cl)cc3Cl)N=C(c3ccccc3)C(c3ccccc3)=N2)c(Cl)c1]

Further, specific examples of the thiol compound used in the photopolymerization initiator of the bimolecular system are shown below.

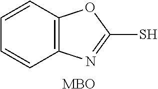

Further, the addition ratio of the photopolymerization initiator is preferably within a range of 0.1 to 20 parts by mass, and more preferably within a range of 0.5 to 10 parts by mass, per 100 parts by mass of the radically polymerizable compound for a binder.

In addition to the photopolymerization initiator described above, other known photopolymerization initiators may be further contained.

[4] Inorganic Particle

The surface protective layer according to the present invention preferably contains inorganic particles, and more preferably contains metal oxide particles as inorganic particles. As the metal oxide particles, metal oxide fine particles including a transition metal are preferable. Examples thereof include metal oxide fine particles such as silica (silicon dioxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide. Among them, it is preferable that any one of tin oxide fine particles, titanium oxide fine particles, zinc oxide fine particles and alumina fine particles is used because the abrasion resistance of the protective layer may be improved.

Preferably, the metal oxide particles are prepared by a known method, for example, a gas phase method, a chlorine method, a sulfuric acid method, a plasma method, and a general manufacturing method such as an electrolytic method.

The number average primary particle diameter of the above metal oxide particles is preferable within a range of, for example, 1 to 300 nm, and particularly preferably within a range of 3 to 100 nm.

Further, the addition ratio of the metal oxide particles is preferably within a range of 1 to 250 parts by mass, and more preferably within a range of 10 to 200 parts by mass, per 100 parts by mass of the radically polymerizable compound for a binder, for example.

[4.1] Measuring Method of Particle Size of Metal Oxide Particles

A particle size of the metal oxide fine particles (number average primary particle diameter) is measures as follows. A scanning electron microscope (manufactured by JEOL Ltd.) is used to take an enlarged photograph of 10000 times of the sample. The photographic image taken by the scanner for randomly selected 300 particles (aggregated particles were removed) is subjected to an automatic image processing analyzer “Luzex™ AP” (manufactured by Nireco Corporation) with software Ver. 1.32. The data is binarized and, the horizontal Feret diameter is calculated respectively. The average value is calculated as the number average primary titanic acid compound. Here, the horizontal Feret diameter refers to the length of the side parallel to the X-axis of the circumscribed rectangle when the image of the metal oxide fine particles is binarized.

[4.2] Surface Modification

In the present invention, it is preferable that the metal oxide particles have a reactive organic group. In other words, from the viewpoint of dispersibility and wear resistance of the photoreceptor, it is preferable to be surface-modified with a surface modifier having a reactive organic group.

As the surface modifier, a surface modifier which reacts with a hydroxy group present on the surface of the metal oxide particles before surface modification may be used, and examples of such a surface modifier include a silane coupling agent and a titanium coupling agent. In addition, in the present invention, for the purpose of further enhancing the hardness of the surface protective layer, a surface modifier having a reactive organic group is preferably used, and more preferably one in which the reactive organic group is a radically polymerizable functional group is used. By using a surface modifier having a radically polymerizable functional group, a strong protective film may be formed in order to react with a radically polymerizable compound for a binder contained in a surface protective layer or a charge transport material. As the surface modifier having a radically polymerizable functional group, a silane coupling agent having an acryloyl group or a methacryloyl group is preferably used, and as the surface modifier having such a radically polymerizable functional group, a known compound as described below is exemplified.
S-1: CH₂═CHSi(CH₃)(OCH₃)₂
S-2: CH₂═CHSi(OCH₃)₃
S-3: CH₂═CHSiCl₃
S-4: CH₂═CHCOO(CH₂)₂Si(CH₃)(OCH₃)₂
S-5: CH₂═CHCOO(CH₂)₂Si(OCH₃)₃
S-6: CH₂—CHCOO(CH₂)₂Si(OC₂H₅)(OCH₃)₂
S-7: CH₂═CHCOO(CH₂)₃Si(OCH₃)₃
S-8: CH₂═CHCOO(CH₂)₂Si(CH₃)Cl₂
S-9: CH₂═CHCOO(CH₂)₂SiCl₃
S-10: CH₂═CHCOO(CH₂)₃Si(CH₃)Cl₂
S-11: CH₂═CHCOO(CH₂)₃SiCl₃
S-12: CH₂═C(CH₃)COO(CH₂)₂Si(CH₃)(OCH₃)₂
S-13: CH₂═C(CH₃)COO(CH₂)₂Si(OCH₃)₃
S-14: CH₂═C(CH₃)COO(CH₂)₃Si(CH₃)(OCH₃)₂
S-15: CH₂═C(CH₃)COO(CH₂)₃Si(OCH₃)₃
S-16: CH₂═C(CH₃)COO(CH₂)₂Si(CH₃)Cl₂
S-17: CH₂═C(CH₃)COO(CH₂)₂SiCl₃
S-18: CH₂—C(CH₃)COO(CH₂)₃Si(CH₃)Cl₂
S-19: CH₂═C(CH₃)COO(CH₂)₃SiCl₃
S-20: CH₂═CHSi(C₂H₅)(OCH₃)₂
S-21: CH₂═C(CH₃)Si(OCH₃)₃
S-22: CH₂═C(CH₃)Si(OC₂H₅)₃
S-23: CH₂═CHSi(OCH₃)₃
S-24: CH₂═C(CH₃)Si(CH₃)(OCH₃)₂
S-25: CH₂═CHSi(CH₃)Cl₂
S-26: CH₂═CHCOOSi(OCH₃)₃
S-27: CH₂═CHCOOSi(OC₂H₅)₃
S-28: CH₂═C(CH₃)COOSi(OCH₃)₃
S-29: CH₂═C(CH₃)COOSi(OC₂H₅)₃
S-30: CH₂═C(CH₃)COO(CH₂)₃Si(OC₂H₅)₃
S-31: CH₂═CHCOO(CH₂)₂Si(CH₃)₂(OCH₃)
S-32: CH₂═CHCOO(CH₂)₂Si(CH₃)(OCOCH₃)₂
S-33: CH₂═CHCOO(CH₂)₂Si(CH₃)(ONHCH₃)₂
S-34: CH₂═CHCOO(CH₂)₂Si(CH₃)(OC₆H₅)₂
S-35: CH₂═CHCOO(CH₂)₂Si(C₁₀H₂₁)(OCH₃)₂
S-36: CH₂═CHCOO(CH₂)₂Si(CH₂C₆H₅)(OCH₃)₂

As the surface modifier, a silane compound having a reactive organic group capable of performing a radical-polymerization reaction may be used in addition to S-1 to S-36 described above. These surface modifiers may be used alone or in combination of 2 or more thereof.

Further, the amount of the surface modifier to be used is not particularly limited, but is preferably within a range of 0.1 to 100 parts by mass per 100 parts by mass of the metal oxide particles before modification, for example.

[4.3] Surface-Modification Method of Metal Oxide Particles

The surface-modification of the metal oxide particles may be specifically performed by wet-grinding a slurry (a suspension of solid particles) containing metal oxide particles before modification and a surface modifier, thereby making the metal oxide particles to be fine and simultaneously proceeding the surface modification of the particles, and then removing the solvent to form a powder.

It is preferable that the slurry is mixed with 100 parts by mass of the metal oxide particles before modification at a ratio of 0.1 to 100 parts by mass of the surface modifier and 50 to 5000 parts by mass of the solvent.

As an apparatus used for wet-grinding of the slurry, a wet media dispersion type apparatus may be cited. The wet media dispersion type device is a device having a step of filling the beads as a medium in the container, further by rotating the agitating disc attached vertically to the rotation axis at high speed, pulverizing and dispersing the aggregated particles of the metal oxide particles. As for the configuration, there is no problem as long as the metal oxide particles are sufficiently dispersed when the surface is modified and the surface may be modified. For example, various styles such as a vertical or horizontal type, and a continuous or batch type may be used. Specifically, a sand mill, an ultra visco mill, a pearl mill, a grain mill, a dyno mill, an agitator mill, or a dynamic mill may be used. These dispersing apparatus perform pulverization and dispersion by impact crushing, friction, shear, and shear stress using grinding media such as balls or beads.

As the beads used in the wet media dispersion type apparatus, for example, a ball using glass, alumina, zircon, zirconia, steel, or flint stone as a raw material may be used, but particularly, those made of zirconia or zircon are preferably used. In addition, as the size of the beads, those having a diameter of about 1 to 2 mm are usually used, but in the present invention, for example, those having a diameter of about 0.1 to 1.0 mm are preferably used.

The disc and the inner wall of the container used in the wet media dispersion type apparatus may be made of various materials such as stainless steel, nylon, and ceramic, but in the present invention, it is particularly preferable that the disc and the inner wall of the container are made of ceramic such as zirconia or silicon carbide.

[5] Other Additives

In addition to the radically polymerizable compound for a binder (binder resin), the charge transport material, the photopolymerization initiator, and the inorganic particles, other components may be contained in the surface protective layer according to the present invention. For example, various kinds of antioxidants, and various kinds of lubricant particles such as fluorine atom-containing resin particles may be added. As the fluorine atom-contain resin particles, for example, 1 or 2 or more kinds of them are preferably appropriately selected from the group of, for example, a tetrafluoroethylene resin, an ethylene trifluoride resin, a hexafluoroethylene propylene chloride resin, a vinyl fluoride resin, a vinylidene fluoride resin, a difluoroethylene resin, and copolymers thereof, but particularly, a tetrafluoroethylene resin and a vinylidene fluoride resin are preferred.

<Conductive Support>

The conductive support may be any conductive support as long as it has conductivity, for example: metal such as aluminum, copper, chromium, nickel, zinc, or stainless steel molded into a drum or sheet shape; metal foil such as aluminum or copper laminated to a plastic film; aluminum, indium oxide or tin oxide vapor-deposited on a plastic film; and metal, plastic film, or paper to which a conductive material is applied alone or together with a binder resin to provide a conductive layer.

<Intermediate Layer>

In the photoreceptor according to the present invention, an intermediate layer having a barrier function and an adhesive function may be provided between the conductive support and the photosensitive layer. In consideration of various failure prevention, it is preferable to provide an intermediate layer.

Such an intermediate layer contains, for example, a binder resin (hereinafter also referred to as a “binder resin for an intermediate layer”) and, if necessary, conductive particles and metal oxide particles.

Examples of the binder resin for an intermediate layer include casein, polyvinyl alcohol, nitrocellulose, ethylene-acrylic acid copolymer, polyamide resin, polyurethane resin, and gelatin. Of these, alcohol-soluble polyamide resins are preferred.

The intermediate layer may contain various conductive particles and metal oxide particles for the purpose of resistance adjustment. For example, various metal oxide particles such as alumina, zinc oxide, titanium oxide, tin oxide, antimony oxide, indium oxide, and bismuth oxide may be used. Further, ultrafine particles such as indium oxide doped with tin, tin oxide doped with antimony, or zirconium oxide may be used. The number average primary particle diameter of such metal oxide particles is, for example, preferably 0.3 μm or less, and more preferably 0.1 μm or less. The number average primary particle diameter of the metal oxide particles may be measured by the same method as the measurement method of the number average primary particle diameter of the metal oxide particles contained in the surface protective layer. These metal oxide particles may be used by 1 kind alone or by mixing 2 or more kinds thereof. When 2 or more of them are mixed, they may be in the form of a solid solution or a fusion. The content ratio of the conductive particles or the metal oxide particles is preferably in the range of 20 to 400 parts by mass, more preferably in the range of 50 to 350 parts by mass, with respect to 100 parts by mass of the binder resin for an intermediate layer, for example.

The thickness of the intermediate layer is preferably within a range of, for example, 0.1 to 15 μm, and more preferably within a range of 0.3 to 10 μm.

<Charge Generating Layer>

The charge generating layer contains a charge generating material and a binder resin (hereinafter also referred to as a “binder resin for a charge generating layer”).

Examples of the charge generating material include azo pigments such as Sudan Red and Diane Blue, quinone pigments such as pyrenequinone and anthanthrone, quinocyanine pigments, perylene pigments, indigo pigments such as indigo and thioindigo, polycyclic quinone pigments such as pyranthrone and diphthaloylpyrene, and phthalocyanine pigments. But examples are not limited thereto. Of these, polycyclic quinone pigments and titanyl phthalocyanine pigments are preferred. These charge generating materials may be used alone, or in combination of two or more kinds.

As the binder resin for a charge generating layer, a known resin may be used. Examples thereof include a polystyrene resin, a polyethylene resin, a polypropylene resin, an acrylic resin, a methacrylic resin, a vinyl chloride resin, a vinyl acetate resin, a polyvinyl butyral resin, an epoxy resin, a polyurethane resin, a polyester resin, an alkyd resin, a polycarbonate resin, a silicone resin, a melamine resin, and a copolymer resin containing two or more of these resins (e.g., a vinyl chloride-vinyl acetate copolymer resin, a vinyl chloride-vinyl acetate-maleic acid copolymer resin), and a poly-vinylcarbazole resin. Examples are not limited thereto. Of these, a polyvinyl butyral resin is preferred.

The content ratio of the charge generating material in the charge generating layer is preferably within a range of 1 to 600 parts by mass, and more preferably within a range of 50 to 500 parts by mass, per 100 parts by mass of the binder resin for a charge generating layer, for example.

The thickness of the charge generating layer varies depending on the characteristics of the charge generating material, the characteristics of the binder resin for a charge generating layer, but the content ratio is preferably 0.01 to 5 μm, more preferably 0.05 to 3 μm.

<Charge Transport Layer>

The charge transport layer contains a charge transport material and a binder resin (hereinafter also referred to as a “binder resin for a charge transport layer”).

As the charge transport material of the charge transport layer, for example, a triphenylamine derivative, a hydrazone compound, a styryl compound, a benzidine compound, and a butadiene compound are cited as a material for transporting the charge.

As the binder resin for a charge transport layer, a known resin may be used, and a polycarbonate resin, a polyacrylate resin, a polyester resin, a polystyrene resin, a styrene-acrylonitrile copolymer resin, a polymethacrylate ester resin, or a styrene-methacrylate copolymer resin may be used. But a polycarbonate resin is preferable. Further, BPA (bisphenol A) type, BPZ (bisphenol Z) type, dimethyl BPA type, and BPA-dimethyl BPA copolymer type polycarbonate resin are preferable in terms of crack resistance, abrasion resistance and charging characteristics.

The content of the charge transport material in the charge transport layer is preferably 10 to 500 parts by mass, more preferably 20 to 250 parts by mass, based on 100 parts by mass of the binder resin for a charge transport layer.

The thickness of the charge transport layer varies depending on the characteristics of the charge transport material, the characteristics of the binder resin for a charge transport layer, and the content ratio, but it is preferably 5 to 40 μm, more preferably 10 to 30 μm.

In the charge transport layer, an antioxidant, an electron conductive agent, a stabilizer, or a silicone oil may be added. The antioxidant disclosed in JP-A 2000-305291 and the electron conductive agent disclosed in JP-A 50-137543 and JP-A 58-76483 are preferable.

[Production Method of Electrophotographic Photoreceptor]

As a method of producing a photoreceptor according to the present invention, for example, it may be produced by passing through the following steps.
Step (1): A coating liquid for forming an intermediate layer is applied to an outer peripheral surface of a conductive support, and the coating liquid is dried to form an intermediate layer.
Step (2): A coating liquid for forming a charge generating layer is applied to an outer peripheral surface of the intermediate layer formed on the conductive support, and the coating liquid is dried to form a charge generating layer.
Step (3): A coating liquid for forming a charge transport layer is applied to an outer peripheral surface of the charge generating layer formed on the intermediate layer, and the coating liquid is dried to form a charge transport layer.
Step (4): A coating liquid for forming a protective layer is applied to an outer peripheral surface of the charge transport layer formed on the charge generating layer to form a coating film, and the coating film is irradiated with ultraviolet rays to be cured to form a protective layer.

Hereinafter, each step will be described.

(Step (1): Formation of an Intermediate Layer)

The intermediate layer may be formed by dissolving a binder resin for the intermediate layer in a solvent to prepare a coating liquid (hereinafter, also referred to as a “coating liquid for forming an intermediate layer”), dispersing conductive particles or metal oxide particles as necessary, coating the coating liquid to a predetermined thickness on a conductive support to form a coating film, and drying the coating film.

As a means for dispersing conductive particles or metal oxide particles in the coating liquid for forming an intermediate layer, for example, an ultrasonic disperser, a ball mill, a sand mill, or a homomixer may be used, but is not limited thereto.

Known methods for applying the coating liquid for forming an intermediate layer include, for example, a dip coating method, a spray coating method, a spinner coating method, a bead coating method, a blade coating method, a beam coating method, a slide hopper method, and a circular slide hopper method.

The method of drying the coating film may be appropriately selected according to the type of the solvent and the thickness of the coating film, but heat drying is preferable.

As the solvent used in the step of forming an intermediate layer, any solvent may be used as long as it satisfactorily disperses the conductive fine particles or the metal oxide fine particles and dissolves the binder resin for an intermediate layer. Specifically, alcohols having 1 to 4 carbon atoms such as methanol, ethanol, n-propyl alcohol, isopropyl alcohol, n-butanol, t-butanol, and sec-butanol are excellent in solubility and coating performance of the binder resin. Further, in order to improve storage stability and dispersibility of particles, the auxiliary solvent may be used in combination with the above solvent, and examples of the auxiliary solvent capable of obtaining a preferable effect include benzyl alcohol, toluene, methylene chloride, cyclohexanone, and tetrahydrofuran.

The concentration of the binder resin for an intermediate layer in the coating liquid for forming an intermediate layer is appropriately selected according to the thickness of the intermediate layer and the production rate.

[Step (2): Formation of a Charge Generating Layer]

The charge generating layer may be formed by dispersing a charge generating material in a solution in which a charge generating layer binder resin is dissolved in a solvent to prepare a coating liquid (hereinafter also referred to as a “coating liquid for forming a charge generating layer”), then applying the coating liquid to a predetermined thickness on the intermediate layer to form a coating film, and drying the coating film.

As a device for dispersing the charge generating material in the coating liquid for forming a charge generating layer, for example, an ultrasonic disperser, a ball mill, a sand mill, or a homomixer may be used, but it is not limited thereto.

The application method of the coating liquid for forming a charge generating layer includes, for example, a known method such as a dip coating method, a spray coating method, a spinner coating method, a bead coating method, a blade coating method, a beam coating method, a slide hopper method, and a circular slide hopper method.

The method of drying the coating film may be appropriately selected according to the type of the solvent and the thickness of the coating film, but heat drying is preferable.

Examples of the solvent used for forming a charge generating layer include, but are not limited to, toluene, xylene, methylene chloride, 1,2-dichloroethane, methyl ethyl ketone, cyclohexane, ethyl acetate, t-butyl acetate, methanol, ethanol, propanol, butanol, methylcellosolve, 4-methoxy-4-methyl-2-pentanone, ethylcellosolve, tetrahydrofuran, 1-dioxane, 1,3-dioxolane, pyridine, and diethylamine.

[Step (3): Formation of a Charge Transport Layer]

The charge transport layer may be formed by preparing a coating liquid in which a charge transport layer binder resin or its raw material component (polymerizable compound) and a charge transport material are dissolved in a solvent (hereinafter also referred to as a “coating liquid for forming a charge transport layer”), then coating the coating liquid to a certain thickness on the charge generating layer to form a coating film, and drying the coating film.

Examples of the application method of a coating liquid for forming a charge transport layer include known methods such as, for example, a dip coating method, a spray coating method, a spinner coating method, a bead coating method, a blade coating method, a beam coating method, a slide hopper coating method, and a circular slide hopper coating method.

The method of drying the coating film may be appropriately selected according to the type of the solvent and the thickness of the coating film, but heat drying is preferable.

Examples of the solvent used for forming the charge transport layer include, but are not limited to, toluene, xylene, methylene chloride, 1,2-dichloroethane, methyl ethyl ketone, cyclohexanone, ethyl acetate, butyl acetate, methanol, ethanol, propanol, butanol, tetrahydrofuran, 1,4-dioxane, 1,3-dioxolane, pyridine, and diethylamine.

(Step (4): Formation of a Surface Protective Layer)

The surface protective layer according to the present invention is cured by irradiating ultraviolet rays to a composition containing a radically polymerizable compound for a binder, a charge transport material, and a photopolymerization initiator, and a surface protective layer is formed.

Specifically, for example, a radically polymerizable compound for a binder, a charge transport material, a photopolymerization initiator, and, if necessary, inorganic particles and other components are added to a known solvent to prepare a coating liquid (hereinafter, also referred to as a “coating liquid for forming a surface protective layer”). Then, the coating liquid for forming a surface protective layer is coated on an outer peripheral surface of the charge transport layer formed by Step (3) to form a coating film, and the surface protective layer may be formed by curing and treating the radically polymerizable compound for a binder in the coating film by drying the coating film and irradiating ultraviolet rays.

In the curing treatment of the surface protective layer, it is preferable that the radically polymerizable compound for a binder forms a crosslinking type curable resin by irradiating ultraviolet rays to the coating film to generate radicals, subjecting the radically polymerizable compound for the binder to a polymerization reaction together with a charge transport material, and forming a crosslinking bond by a crosslinking reaction between molecules and in molecules to be cured.

In the coating liquid for forming a surface protective layer, the inorganic particles are preferably contained within a range of 5 to 60 parts by volume per 100 parts by volume of the radically polymerizable compound for a binder, and more preferably within a range of 10 to 60 parts by volume. Further, the charge transport material is preferably contained within a range of 5 to 75 parts by volume per 100 parts by volume of the radically polymerizable compound for a binder, and more preferably within a range of 5 to 50 parts by volume. Further, the photopolymerization initiator is preferably contained within a range of 0.1 to 20 parts by mass, and more preferably within a range of 0.5 to 10 parts by mass, per 100 parts by mass of the radically polymerizable compound for a binder, for example.

As a means for dispersing the inorganic particles and the charge transport material in the coating liquid for forming a surface protective layer, for example, an ultrasonic disperser, a ball mill, a sand mill, or a homomixer may be used, but is not limited thereto.

As a solvent used for forming a surface protective layer, any solvent may be used as long as it may dissolve or disperse a radically polymerizable compound for a binder, a charge transport material, a photopolymerization initiator, and inorganic particles. Examples thereof include, but are not limited to, methanol, ethanol, n-propyl alcohol, isopropyl alcohol, n-butanol, t-butanol, sec-butanol, benzyl alcohol, toluene, xylene, dichloromethane, methyl ethyl ketone, cyclohexane, ethyl acetate, butyl acetate, methyl cellosolve, ethyl cellosolve, tetrahydrofuran, 1,4-dioxane, 1,3-dioxolane, pyridine, and diethylamine.

Methods of coating the coating liquid for forming a surface protective layer include, for example, publicly-known methods such as a dip coating method, a spray coating method, a spinner coating method, a bead coating method, a blade coating method, a beam coating method, a slide hopper method, and a circular slide hopper method.

For the coating film, a curing treatment may be performed without drying, but it is preferable to perform a curing treatment after performing natural drying or heat drying.

The conditions for drying may be appropriately selected depending on the type of solvent and film thickness. The drying temperature is preferably within the range of room temperature (25° C.) to 180° C., and particularly preferably within the range of 80 to 140° C. The drying time is preferably from 1 to 200 minutes, particularly preferably from 5 to 100 minutes.

As the ultraviolet light source, any light source that generates ultraviolet rays may be used without limitation. For example, a low-pressure mercury lamp, a medium-pressure mercury lamp, a high-pressure mercury lamp, an ultra-high-pressure mercury lamp, a carbon arc lamp, a metal halide lamp, a xenon lamp, or a flash (pulse) xenon lamp may be used. Although irradiation conditions vary depending on the respective ramps, the irradiation amount of the active ray is typically 5 to 500 mJ/cm², preferably 5 to 100 mJ/cm². The power of the lamp is preferably 0.1 kW to 5 kW, particularly preferably 0.5 kW to 3 kW.

As an irradiation time for obtaining an irradiation amount of ultraviolet rays required, for example, from 0.1 seconds to 10 minutes is preferable, and from the viewpoint of working efficiency, from 0.1 seconds to 5 minutes is more preferred.

In the step of forming a surface protective layer, drying may be performed before and after irradiation with ultraviolet rays and during irradiation with ultraviolet rays, and the timing at which drying is performed may be appropriately selected by combining these.

[Toner for Developing an Electrostatic Charge Image]

The toner used in the image forming method of the present invention has toner base particles of a core-shell structure having a shell layer of 10% by mass or less of the mass of the toner base particle on an outside of the resin constituting the core particle, and the solubility parameter value (SPs) of the resin constituting the shell layer is 10.75 or less.

In the present invention, the toner base particles to which the external additive is added are referred to as toner particles, and the aggregate of the toner particles is referred to as a toner. Although the toner base particles may be generally used as toner particles even as they are, in the present invention, those obtained by adding an external additive to the toner base particles are used as toner particles.

The toner base particles according to the toner used in the present invention are particles mainly containing a binder resin, and contain, in addition to the binder resin, an internal additive such as a colorant, a releasing agent, and a charge control agent, for example.

<Toner Base Particles>

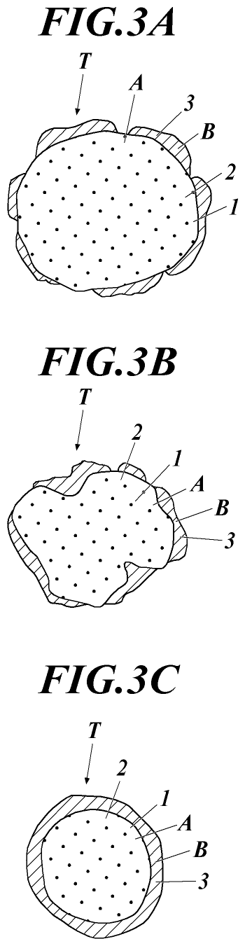

The toner base particles according to the present invention have a core-shell structure. FIG. 3A to FIG. 3C are a schematic diagram showing a structure of a toner base particle according to the present invention. In FIG. 3A to FIG. 3C, T denotes a toner base particle, A denotes a core particle, B denotes a shell layer, 1 denotes a colorant particle, 2 denotes a resin constituting a core particle, and 3 denotes a resin constituting a shell layer.

It is preferable that the toner base particles according to the present invention be obtained by forming a shell layer by salting-out/aggregating resin particles formed using a resin having a solubility parameter value different from that of the core particle within a range of 0.20 to 0.70 on the surface of the core particle A containing the resin and the colorant in the manufacturing process thereof.

The thickness of the shell layer of the toner base particle is preferable in the range of 10 to 500 nm, and more preferably in the range of 100 to 300 nm.

The shell layer may be coated to such an extent that it has an effect of solving the problem of the present invention even if the core particle surface is not necessarily completely coated. As shown in FIG. 3A, by covering the surface of the core particle with an area ratio of 70% or more, preferably 80% or more, it is possible to satisfy both the fixing property at a low temperature and the heat storage resistance at the time of storage. In addition, as shown in FIG. 3B, a part of the shell layer may be inserted into the core particle, and the same effect as that obtained by covering the entire surface of the core particle with the shell layer as shown in FIG. 3C is exhibited.

Here, the formation of the shell layer is defined as the formation of the shell layer on the surface of the core particle when the layer covering the outer surface of the core particle is 70% or more of the surface area of the outer surface of the core particle.

In the present invention, the surface coverage rate (the surface area %, which is referred to as the surface coverage rate) and the film thickness of the shell layer are determined by visually observing a region (core particle) in which a colorant (carbon black, yellow pigment, magenta pigment, and cyan pigment) or a releasing agent) exists (on the core particle) from a

TEM (Transmission Electron Microscope) photograph of the toner, and the distance from the outermost surface of the toner to the core particles is randomly measured at ten points, and the film thickness of the shell layer is calculated from the average value. The number of toners for which TEM photographing is performed is 50 or more at least.

Further, it is preferable not to contain wax in the shell layer constituting the outermost layer. This is because, when a layer containing no wax is formed in the outermost layer, wax release is suppressed, and image defects in the actual machine durability test are less likely to occur.

Although it is not clear why the toner according to the present invention may achieve both the fixing property at a low temperature and the heat storage resistance at the time of storage, it is presumed that the core particle and the shell layer are incompatible at the molecular level, and therefore, even if the core particle inside the toner particle is composed of a resin having a low softening temperature and a low glass transition temperature, the resin constituting the shell layer does not cause the phenomenon of lowering of the glass transition temperature or plasticizing due to the influence of the resin constituting the core particle. As a result, it is presumed that the toner of the present invention is capable of achieving both of the fixing property at a low temperature and the heat-resistant storage property.

(Method of Detecting a Structure of Toner Particles)

The structure of the toner particles according to the present invention may be observed by a transmission electron microscope (TEM) by sectioning the toner particles to 80 to 200 nm. Examples of the transmission electron microscopy apparatus (TEM) include “H-9000NAR” (manufactured by Hitachi, Ltd.) and “JEM-200FX” (manufactured by JEOL Ltd.). In the present invention, the size of the core particles and the thickness of the shell layer in the toner base particles may be calculated from the projection surface of 50 or more toner particles at a magnification of 10,000 times by the result of the transmission electron micrograph. Incidentally, the magnification of the observation may be adjusted within a range in which the cross-sectional structure of one toner particle may be observed.

The observation method by a transmission electron microscope is performed by a conventional method that is performed when measuring the structure of the toner particle.

For example, first, a toner sample for observation is produced. Toner particles are sufficiently dispersed in an epoxy resin having ordinary temperature curability, and then embedded and cured to prepare a block. Using a microtome equipped with a diamond blade, the produced block is cut into slices with a thickness of 80 to 200 nm to prepare a sample for measurement.

Next, a photograph of the cross-sectional form of the toner particles is taken using a transmission electron microscope (TEM). The composition of the resin layer in the toner particles is visually confirmed from the photograph. It is also possible to measure the particle size of the core particles and the layer thickness of the shell layer in the toner particles by calculating and processing the image information taken by the image processing device “Luzex™ F” (manufactured by Nireco Corporation) as necessary.

In some cases, the measurement sample may be stained with ruthenium tetroxide, or osmium tetroxide.

(Softening Temperature)

The softening temperature Tsp of the toner according to the present invention is preferably in the range of 70 to 98° C. When the toner having the softening temperature in this range is used, fixing may be performed even when the temperature of the surface of the transfer material at the time of fixing is 100° C. or less. Therefore, the toner according to the present invention may be fixed at a temperature at which image defects or deformation (curling) of the transfer material due to the generation of water vapor does not occur.

For measuring the softening temperature of a toner, for example, a “Flow Tester CFT-500” (manufactured by Shimadzu Corporation) is used, and the sample is formed into a columnar shape having a height of 10 mm after having been adjusted to a particle size of 9.2 mesh-pass (opening 2.0 mm) and 32 mesh-on (opening 0.5 mm) in advance, and a 200 N/cm² load is applied from the plunger while being heated at a temperature rising rate of 6° C./min to push out nozzles having a diameter of 1 mm and a length of 1 mm, whereby a curve (softening flow curve) between the plunger lowering amount and the temperature of the flow tester is drawn, and the temperature for a lowering amount of 5 mm is set to the softening temperature.

(Molecular Weight)

In preparing the toner according to the present invention, it is preferable to set the molecular weight of the resin constituting the core particle and the shell layer in the toner particle to a specific range, respectively.

Specifically, it is preferable to set the weight average molecular weight of the resin constituting the core particle within a range of 5000 to 30000, the weight average molecular weight of the resin constituting the shell layer within a range of 10000 to 80000, and further, the weight average molecular weight of the resin constituting the core particle within a range of 15000 to 28000, and the weight average molecular weight of the resin constituting the shell layer within a range of 10000 to 50000, as a peak molecular weight, respectively.

Next, a material used in the present invention will be described.

<Resin>

The resin for forming the core particle and the resin for forming the shell layer are preferably a styrene-acrylic copolymer resin. In the toner of the present invention, it is preferable that the glass transition temperature (Tg) of the resin constituting the shell layer is higher than the glass transition temperature (Tg) of the resin constituting the core particle in terms of low-temperature fixability and heat-resistant storage property. It is preferable that the glass transition temperature of the resin constituting the shell layer is higher than the glass transition temperature of the resin constituting the core particle within a range of 5 to 15° C. Specifically, the glass transition temperature of the resin constituting the shell layer is preferably within a range of 50 to 70° C., and the glass transition temperature of the resin constituting the core particle is preferably within a range of 36 to 55° C.

Note that the glass transition temperature (Tg) of the resin in the present invention is a value measured using “Diamond DSC” (manufactured by Perkin Elmer Japan Co., Ltd.). As a measurement procedure, 3.0 mg of a measurement sample (resin) was enclosed in an aluminum pan and set in a holder. An empty aluminum pan was used as a reference. The measurement condition is as follows: the measurement temperature is 0 to 200° C., the temperature rise rate is 10° C./min, and the temperature fall rate is 10° C./min. The temperature is controlled by Heat-Cool-Heat temperature control. Analysis is performed on the basis of the data in the second Heat. The extension line of the baseline prior to the rise of the first endothermic peak and the tangent line indicating the largest slope are drawn between the rising part of the first peak and the peak apex, and the intersection point is defined as the glass transition temperature.

It is preferable to copolymerize a polymerizable monomer which lowers the glass transition temperature (Tg) of a copolymer such as propyl acrylate, propyl methacrylate, butyl acrylate, butyl methacrylate, 2-ethylhexyl acrylate, or 2-ethylhexyl methacrylate as a monomer for producing a resin constituting the core particle.

The copolymer ratio of the above-mentioned polymerizable monomer in the copolymer resin constituting the core particle is preferably within a range of 8 to 80% by mass, and more preferably within a range of 9 to 70% by mass.

In addition to the above, these polymerizable monomers may be those having a form of an acid, an acid anhydride, or a vinyl carboxylic acid metal salt.

Further, in the present invention, a copolymer resin that forms core particles may be formed by using a styrene-based monomer in combination.

It is preferable to copolymerize a polymerizable monomer which raises the glass transition temperature (Tg) of a copolymer such as styrene, methyl methacrylate, or methacrylic acid as a monomer for producing a resin constituting a shell layer.

The copolymer ratio of the above-mentioned polymerizable monomer in the copolymer resin constituting the shell layer is preferably within a range of 8 to 80% by mass, and more preferably within a range of 9 to 20% by mass.

Further, these polymerizable monomers may be those having an acid anhydride or a vinyl carboxylic acid metal salt form.

(Polymerizable Monomer)

As a polymerizable monomer for obtaining a resin constituting a toner according to the present invention, a radically polymerizable monomer is used as an essential constituent, and in particular, at least 1 kind of monomer selected from radically polymerizable monomers having an acidic group are preferably used. Also, a crosslinking agent may be used if necessary. Examples of such radically polymerizable monomers include an aromatic vinyl monomer, a (meth)acrylic acid ester monomer, a vinyl ester monomer, a vinyl ether monomer, a monoolefin monomer, a diolefin monomer, and a halogenated olefin monomer.

Examples of the aromatic vinyl monomer include styrene-based monomers such as styrene, o-methylstyrene, m-methylstyrene, p-methylstyrene, p-methoxystyrene, p-phenylstyrene, p-chlorostyrene, p-ethylstyrene, p-n-butylstyrene, p-n-hexylstyrene, p-n-octylstyrene, p-n-nonylstyrene, p-n-decylstyrene, p-n-dodecylstyrene, 2,4-dimethylstyrene, and 3,4-dichlorostyrene; and derivatives thereof.

Examples of the (meth)acrylic acid ester monomer include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl O-hydroxyacrylate, propyl γ-aminoacrylate, stearyl methacrylate, dimethylaminoethyl methacrylate, and diethylaminoethyl methacrylate.

Examples of the vinyl ester monomer include vinyl acetate, vinyl propionate, and vinyl benzoate.

Examples of the vinyl ether monomer include vinyl methyl ether, vinyl ethyl ether, vinyl isobutyl ether, and vinyl phenyl ether.

Examples of the monoolefin monomer include ethylene, propylene, isobutylene, 1-butene, 1-penten, and 4-methyl-1-penten.

Examples of the diolefin monomer include butadiene, isoprene, and chloroprene.

Examples of the halogenated olefin monomer include vinyl chloride, vinylidene chloride, and vinyl bromide.

Radically polymerizable monomers having an acid group include carboxylic acid group-containing monomers such as acrylic acid, methacrylic acid, fumaric acid, maleic acid, itaconic acid, cinnamic acid, maleic acid monobutyl ester, maleic acid monooctyl ester, or sulfonic acid group-containing monomers such as styrene sulfonic acid, allylsulfosuccinic acid, allylsulfosuccinic acid octyl. All or a part of the radically polymerizable monomer having an acidic group may be a structure of an alkali metal salt such as sodium or potassium or an alkaline earth metal salt such as calcium. The proportion of the radically polymerizable monomer having an acidic group in the monomer (content, monomer mixture) to be used is preferably within a range of 0.1 to 25% by mass.

In order to improve characteristics such as stress resistance of the toner, a radically polymerizable crosslinking agent may be added and copolymerized with the radically polymerizable monomer. Examples of such a radically polymerizable crosslinking agent include compounds having 2 or more unsaturated bonds such as divinylbenzene, divinylnaphthalene, divinyl ether, diethylene glycol methacrylate, ethylene glycol dimethacrylate, polyethylene glycol dimethacrylate, and diallyl phthalate. The proportion of the radically polymerizable crosslinking agent in the monomer (monomer mixture) to be used is preferably within a range of 0.1 to 10% by mass.

<Chain Transfer Agent>

In order to adjust the molecular weight of the resin, it is possible to use a commonly used chain transfer agent. The chain transfer agent used is not particularly limited, and for example, mercaptans such as octyl mercaptan, dodecyl mercaptan, and tert-dodecyl mercaptan, a mercaptopropionic acid ester such as n-octyl-3-mercaptopropionic acid ester, terpinolene, carbon tetrabromide, and α-methylstyrene dimer are used.

<Radical Polymerization Initiator>

The radical polymerization initiator used in the present invention may be appropriately used as long as it is water-soluble. Examples thereof include persulfates such as potassium persulfate and ammonium persulfate, 4,4′-azobis 4-cyanovaleric acid and salts thereof, azo-based compounds such as 2,2′-azobis(2-amidinopropane) salts, and peroxide compounds.

Further, the above radical polymerization initiator may be used as a redox-based initiator in combination with a reducing agent if necessary. By using a redox-based initiator, polymerization activity increases and polymerization temperature decreases, and further reduction in polymerization time may be expected.

<Surfactant>

When carrying out emulsion polymerization using the radically polymerizable monomer, there is no particular limitation on the surfactant which may be used, but the following ionic surfactant is suitably used.

Examples of the ionic surfactant include sulphonates (sodium dodecylbenzene sulfonate, sodium arylalkylbenzenesulfonate, sodium 3,3-disulphonediphenylurea-4,4-diazo-bis-amino-8-naphthol-6-sulfonate, ortho-carboxybenzene-azo-dimethylaniline, and sodium 2,2,5,5-tetramethyltriphenylmethane-4,4-diazo-bis-β-naphthol-6-sulfonate); sulfate ester salts (sodium dodecyl sulfate, sodium tetradecyl sulfate, sodium pentadecyl sulfate, and sodium octyl sulfate); fatty acid salts (sodium oleate, sodium laurate, sodium caprate, sodium caprylate, sodium caproate, potassium stearate, and calcium oleate).

Also, nonionic surfactants may be used. Specific examples thereof include polyethylene oxide, polypropylene oxide, a combination of polypropylene oxide and polyethylene oxide, an ester of polyethylene glycol and higher fatty acid, an alkylphenol polyethylene oxide, an ester of higher fatty acid and polyethylene glycol, an ester of higher fatty acid and polypropylene oxide, and a sorbitan ester, but if necessary, polymerization may be performed in combination with the aforementioned ionic surfactant.

In the present invention, these are mainly used as emulsifiers at the time of emulsion polymerization, but they may be used for other processes or purposes of use, for example, for a dispersant of associated particles.

<Colorant>

As the colorant used in the present invention, all known dyes and pigments may be used. Specifically used examples are Carbon Black, Nigrosine Dye, Iron Black, Naphthol Yellow S, Hansa Yellow (10G, 5G, G), Cadmium Yellow, Yellow Iron Oxide, Yellow Ocher, Titanium Yellow Polyazo Yellow, Oil Yellow, Hansa Yellow (GR, A, RN, R), Pigment Yellow L, Permanent Yellow (NCG), Vulcan Fast Yellow (5G, R), Tartrazin Lake, Quinoline Yellow Lake, Anthrazan Yellow BGL, Isoindolinone Yellow, Bengala, Permanent Red 4R, Para Red, Fire Red, p-Chloro-o-Nitroaniline Red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubin B, Brilliant Scarlet G, Lithol Rubine GX, Permanent Red FSR, Brilliant Carmin 6B, Pigment Scarlet 3B, Bordeaux 5B, Toluidine Maroon, Permanent Bordeaux F2K, Helio Bordeaux BL, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazo Red, Chrome Vermilion, Benzidine Orange, Perinone Orange, Oil Orange, Cobalt Blue, Cerulean Blue, Alkaline Blue Lake, Peacock Blue Lake, Victoria Blue Lake, metal-free Phthalocyanine Blue, Phthalocyanine Blue, Fast Sky Blue, Indanthrene Blue (RS, BC), Indigo, Ultramarine, Prussian Blue, Anthraquinone Blue, Fast Violet B, Methyl Violet Lake, Cobalt Purple, Manganese Purple, Dioxane Violet, Anthraquinone Violet, Chrome Green, Zink Green, Viridian, Emerald Green, Pigment Green B, Naphthol Green B, Green Gold, Acid Green Lake, Malachite Green Lake, Phthalocyanine Green, Anthraquinone Green, Titanium Oxide, Lithopone and mixtures thereof.

The content of the colorant is preferably within a range of 1 to 20 parts by mass per 100 parts by mass of the resin (binder resin).

<Charge Control Agent>

The toner of the present invention may contain a charge control agent if necessary. All of the known charge control agents may be used, and examples thereof include a fluorine-based active agent, a metal salt of a salicylic acid, and a metal salt of a salicylic acid derivative. Specifically examples thereof include BONTRON 03 of a nigrosine dye, BONTRON P-51 of a quaternary ammonium salt, BONTRON S-34 of an azo-based metal complex salt compound, E-82 of an oxynaphthoic acid-based metal complex, E-89 of a phenolic-based condensate (manufactured by Orient Chemical Industries, Ltd.); TP-302, TP-415 of a quaternary ammonium salt molybdenum salt (manufactured by Hodogaya Chemical Co., Ltd.); Copy charge PSY VP2038 of a quaternary ammonium salt, Copy blue PR of a triphenylmethane derivative, Copy charge NEGVP2036 and copy charge NX VP434 of a quaternary ammonium salt (manufactured by Hoechst AG); LRA-901, a LR-147 which is a boron complex (manufactured by Japan Carlit Co., Ltd.), and a polymer compound having a functional group such as a sulfonic acid group, a carboxyl group, or a quaternary ammonium salt. Among these, an azo-based metal complex salt compound is preferable, and, for example, those disclosed in paragraphs 0009 to 0012 of JP-A 2002-351150 are preferably used.

In the present invention, the amount of the charge control agent to be used is determined by a toner manufacturing method including the type of the binder resin, the presence or absence of an additive to be used if necessary, and the dispersion method, and is not meaningfully limited, but is preferably used within a range of 0.1 to 2 parts by mass per 100 parts by mass of the binder resin. More preferably, it is within a range of 0.2 to 5 parts by mass.

In the present invention, it is preferable that the charge control agent is contained in the vicinity of the toner particle surface. That is, it is possible to effectively impart the charging property to the toner particle by being contained in the vicinity of the toner particle surface, and to secure the fluidity of the toner particle by containing the charge control agent so as not to expose the toner particle surface.

Specific examples of the incorporation method include a method of controlling the amount of the charge control agent added to the resin particles constituting the toner. That is, there are a method in which the charge control agent is added to a large amount of the resin particles constituting the vicinity of the surface of the toner particle, and the resin particles are agglomerated so as to form the toner particle surface with the resin particles to which the charge control agent is not added, and a method in which the resin particles containing the charge control agent are agglomerated and then encapsulated with the resin component not containing the charge control agent on the surface of the agglomerated particles.

As a method to be contained in the resin particles, it may be kneaded together with a binder resin, and the dispersion diameter thereof is adjusted, or when it is desorbed, it may be added to the aqueous phase side and incorporated into the toner particles during the aggregation step or the drying step.

<External Additive>

As an external additive to be externally added to the toner base particles according to the present invention, various inorganic oxides, nitrides, and borides are suitably used as materials constituting the inorganic fine particles. Examples thereof include silica, alumina, titania, zirconia, barium titanate, aluminum titanate, strontium titanate, magnesium titanate, cerium oxide, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, and boron nitride. Further, it is preferable that the inorganic fine particles are subjected to hydrophobization treatment by a silane coupling agent, or a titanium coupling agent.

As the organic fine particles, spherical organic fine particles having a number average primary particle diameter of about 10 to 2000 nm may be used. Specifically, styrene resin fine particles, styrene/acrylic resin fine particles, polyester resin fine particles, and urethane resin fine particles are preferably used.

As a lubricant which may be used as an external additive, a metal salt of a higher fatty acid may be mentioned. Specific examples of such metal salts of higher fatty acids include metal salts of stearates such as zinc stearate, aluminum stearate, copper stearate, magnesium stearate, and calcium stearate; metal salts of oleic acid such as zinc oleate, manganese oleate, iron oleate, copper oleate, and magnesium oleate; metal salts of palmitic acid such as zinc palmitate, copper palmitate, magnesium palmitate, and calcium palmitate; metal salts of linoleic acid such as zinc linoleate and calcium linoleate; metal salts of ricinoleic acid such as calcium ricinoleate.

[Production Method of Toner]

As described above, the method of manufacturing the toner is not particularly limited as long as the toner contains the toner base particles of a core-shell structure having a shell layer of 10% by mass or less with respect to the mass of the toner base particle disposed outside the resin constituting the core particle, and the solubility parameter value (SPs) of the resin constituting the shell layer is 10.75 or less. Examples of the manufacturing method include a suspension polymerization method, an emulsion polymerization aggregation method, a miniemulsion polymerization aggregation method, a dispersion polymerization method, a solution suspension method, a melting method, and a kneading and pulverization method. Among them, an emulsion polymerization aggregation method and a miniemulsion polymerization aggregation method are preferably used because of ease of introduction of an additive into a shell layer, easiness of control of a layer configuration.

When a toner according to the present invention is produced, each step will be described in detail later, but is produced at least through the following steps.

First, resin particles and colorant particles are aggregated and fused to form core particles (hereinafter referred to as “core particles”). Next, resin particles are added into the core particle dispersion to aggregate and fuse the resin particles on the surface of the core particle, thereby coating the surface of the core particle to produce colored particles having a core-shell structure. As described above, the toner according to the present invention is produced with a toner containing toner base particles having a core-shell structure by adding resin particles to a dispersion of core particles produced by various manufacturing methods and fusing them to the core particles.

Hereinafter, a miniemulsion polymerization aggregation method will be described.
(1) Dissolution/dispersion step for dissolving or dispersing a releasing agent in a radically polymerizable monomer
(2) Polymerization step for preparing a dispersion of resin fine particles
(3) Aggregation and fusion step in which resin fine particles and colorant particles are aggregated and fused in an aqueous medium to obtain core particles (associated particles)
(4) First ripening step in which the core particles are ripened by thermal energy to adjust the shape
(5) Shelling step in which shell resin particles are added to a core particle dispersion to agglomerate and fuse shell particles on the core particle surface to form core-shell structured toner base particles
(6) Second ripening step in which the colored particles of a core-shell structure are ripened by thermal energy to adjust the shape of the toner base particles of a core-shell structure
(7) Cleaning step for solid-liquid separation of toner base particles from cooled toner base particle dispersion liquid and removal of surfactant from the toner base particles
(8) Drying step for drying the washed toner base particles

If necessary, after the drying step, the following step may be done.
(9) Adding step of an external additive to the dried toner base particles

Hereinafter, each manufacturing step of the toner according to the present invention will be described.

(1) Dissolution/Dispersion Step

In this step, a releasing agent is dissolved in a radically polymerizable monomer to prepare a radically polymerizable monomer solution by mixing a releasing agent.

(2) Polymerization Step

In one preferred example of this polymerization step, a radically polymerizable monomer solution containing a wax dissolved or dispersed is added in an aqueous medium containing a surfactant having a critical micelle concentration (CMC) or less, mechanical energy is added to form a droplet, and then a water-soluble radical polymerization initiator is added, and the polymerization reaction proceeds in the droplet. Note that an oil-soluble polymerization initiator may be contained in the liquid droplets. In such a polymerization step, forcibly emulsifying (forming droplets) by applying mechanical energy is indispensable. Examples of the device for applying such mechanical energy include devices for applying strong stirring or ultrasonic vibration energy such as a homomixer, a ultrasonic wave mixer, and a Manton Gaulin homogenizer.

By this polymerization step, resin fine particles containing wax and a binder resin are obtained. Such resin fine particles may be colored fine particles or may be fine particles which are not colored. The colored resin fine particles are obtained by subjecting a monomer composition containing a colorant to a polymerization treatment. In addition, when the resin fine particles which are not colored are used, in the aggregation and fusion step described later, a dispersion of the colorant fine particles is added to the dispersion of the resin fine particles, and the resin fine particles and the colorant fine particles are fused to each other, so that the colored particles may be obtained.

(3) Aggregation and Fusing Step

As an aggregation and fusing method in the fusing step, a salting-out/fusing method using resin fine particles (colored or non-colored resin fine particles) obtained by the polymerization step is preferred. In addition, in the aggregation and fusion step, together with the resin fine particles and the colorant fine particles, the internal additive fine particles such as the releasing agent fine particles and the charge control agent may be aggregated and fused.

The term “salting-out/fusing” as used herein means that, when aggregation and fusion are advanced in parallel and grown to a desired particle diameter, then an aggregation stopping agent is added to stop particle growth, and further, heating for controlling particle shape is continuously performed if necessary.

The term “aqueous medium” in the aggregation and fusion step refers to one in which a main component (50% by mass or more) is made of water. Here, examples of the component other than water include an organic solvent dissolved in water, and examples thereof include methanol, ethanol, isopropanol, butanol, acetone, methyl ethyl ketone, and tetrahydrofuran.

Colorant microparticles may be prepared by dispersing a colorant in an aqueous medium. The dispersion treatment of the colorant is performed in water with the surfactant concentration at or above the critical micelle concentration (CMC). The disperser used for the dispersion treatment of the colorant is not particularly limited, but preferably, an ultrasonic disperser, a mechanical homogenizer, a pressure disperser such as a Manton Gaulin homogenizer or a pressure type homogenizer, a sand grinder, a media-type disperser such as a Getzmann mill or a Diamond fine mill may be cited. Further, examples of the surfactant used include the same surfactants as described above. Note that the colorant (fine particles) may be surface-modified. In the surface-modification method of a colorant, a colorant is dispersed in a solvent, a surface modifier is added in the dispersion, and the system is reacted by raising the temperature. After completion of the reaction, the colorant is filtered off, and washing filtration is repeated with the same solvent, followed by drying, thereby obtaining a colorant (pigment) treated with a surface modifier.

In the salting-out/fusing method which is a preferable aggregation and fusion method, a salting-out agent composed of an alkali metal salt, an alkaline earth metal salt, or a 3 valent salt is added as a coagulant having a critical aggregation concentration or higher in water in which the resin fine particles and the colorant fine particles are present. Next, it is a step of advancing salting-out and at the same time performing fusion by heating to a temperature equal to or higher than the glass transition point of the resin fine particles and equal to or higher than the melting peak temperature (° C.) of the mixture. Here, the alkali metal salt and the alkaline earth metal salt which are salting-out agents are as follows. Examples of the alkali metal include lithium, potassium, and sodium, and examples of the alkaline earth metal include magnesium, calcium, strontium, and barium, and preferably potassium, sodium, magnesium, calcium, and barium.

When aggregation and fusion are performed by salting-out/fusing, it is preferable to shorten the time for leaving after adding the salting-out agent as much as possible. Although the reason for this is not clear, the agglomeration state of the particles fluctuates depending on the leaving time after the salting-out, and there arises a problem that the particle size distribution becomes unstable or the surface property of the fused toner fluctuates. Further, it is necessary that the temperature at which the salting-out agent is added is at least equal to or lower than the glass transition temperature of the resin fine particles. As a reason for this, when the temperature at which the salting-out agent is added is equal to or higher than the glass transition temperature of the resin fine particles, salting-out/fusing of the resin fine particles proceeds quickly, but control of the particle diameter may not be performed, and a problem may arise in which particles having a large particle diameter are generated.

Further, a salting-out agent is added at a temperature lower than or equal to the glass transition temperature of the resin fine particles, and then the temperature is increased as quickly as possible, and is heated to a temperature equal to or higher than the glass transition temperature of the resin fine particles and equal to or higher than the melting peak temperature (° C.) of the mixture. As the time to this temperature rise is preferably less than 1 hour. Further, although it is necessary to quickly perform the temperature rise, the temperature rise rate is preferably 0.25° C./min or more. Although the upper limit is not particularly clear, there is a problem in that it is difficult to control the particle size because the salting-out proceeds rapidly when the temperature is raised instantaneously, and 5° C./minute or less is preferable. By this fusion step, a dispersion liquid of associated particles (core particles) obtained by salting-out/fusion of resin fine particles and arbitrary fine particles is obtained.

(4) First Ripening Step

In the present invention, it is preferable to control the heating temperature of the aggregation and fusion step, and in particular, the heating temperature and time of the first ripening step, so that it is possible to control the surface of the core particles which are formed to have a certain particle diameter and narrow distribution to have a smooth but uniform shape. Specifically, to promote homogenization by suppressing the progress of fusion between the resin particles by lowering the heating temperature in the aggregation and fusion step, to lower the heating temperature in the first ripening step, and, it is preferable to control the surface of the core particles by increasing the time to have a uniform shape.

(5) Shelling Step

In the shelling step, a resin particle dispersion for a shell is added into the core particle dispersion to aggregate and fuse the resin particles for a shell on the surface of the core particle, and the resin particles for a shell are coated on the surface of the core particle to form a toner base particle.

Specifically, in the core particle dispersion, a dispersion of resin particles for a shell is added in a state in which the temperature in the above aggregation and fusion step and the first aging step is maintained, and the resin particles for a shell are slowly coated on the surface of the core particle over a period of several hours while continuing the heating and stirring to form a toner base particle.

When a plurality of layers are provided, a resin which forms a layer on a side close to the core particles is added, and a resin which is adsorbed on the core particle, and then a resin which forms a next layer is added, and a shell layer is sequentially formed. If it is adsorbed regardless of the state of fusion of the previously added resin for a shell to the core particles, a resin for a next shell may be added. It is sufficient that each layer is fused at the stage where the outermost layer is fused.

Further, as a method for producing resin particles for a shell, a wax seed polymerization method using wax dispersion particles as seed particles is preferably used because a large amount of a releasing agent is easily incorporated into particles.

(6) Second Ripening Step

A terminating agent such as sodium chloride is added at a stage where the toner base particles become a predetermined particle size by shelling to stop the particle growth, and then heating and stirring is continued for several hours to fuse the resin particles for the shell adhering to the core particles. Then, in the shelling step, a shell having a thickness of 100 to 300 nm is formed on the surface of the core particle. In this manner, the resin particles are fixed to the surface of the core particles to shape a shell, and the toner base particles having rounded and uniform shapes are formed.

In the present invention, it is possible to control the shape of the toner base particles in the true sphere direction by setting the time of the second ripening step longer or setting the ripening temperature higher.

(7) Cooling Step, Solid-Liquid Separation and Cleaning Step

This step is a step of subjecting a dispersion of the toner base particles to a cooling step (rapid cooling treatment). As the cooling treatment conditions, cool at a cooling rate of 1 to 20° C./min. The cooling treatment method is not particularly limited, and a method of introducing a refrigerant from the outside of the reaction vessel to cool the reaction vessel, or a method of directly introducing cold water into the reaction system to cool the reaction vessel may be exemplified.

In this solid-liquid separation and cleaning step, a solid-liquid separation treatment is performed for solid-liquid separation of the toner base particles from the dispersion of toner base particles cooled to a predetermined temperature in the above step, and a cleaning treatment is performed to remove deposits such as a surfactant and a salting-out agent from the solid-liquid separated toner cake (an aggregate of toner base particles in a wet state aggregated into a cake shape). Here, the filtration treatment method is not particularly limited, such as a centrifugal separation method, a reduced pressure filtration method performed using a Nutsche, or a filtration method performed using a filter press.

(8) Drying Step

This step is a step of drying and the washed cake to obtain dried toner base particles. The dryer used in this step may be a spray dryer, a vacuum freeze dryer, or a vacuum dryer, and it is preferable to use a static shelf dryer, a mobile shelf dryer, a fluidized bed dryer, a rotary dryer, or a stirred dryer. The moisture content of the dried toner base particles is preferably 5% by mass or less, and more preferably 2% by mass or less. When the toner base particles subjected to the drying treatment are aggregated with a weak inter-particle attraction, the aggregates may be subjected to a crushing treatment. As the crushing apparatus, a mechanical crushing apparatus such as a jet mill, a Henschel mixer, a coffee mill, or a food processor maybe used.

(9) External Addition Step

This step is a step of mixing an external additive to the dried toner base particles as necessary to prepare a toner.

As a mixing apparatus for an external additive, a mechanical mixing device such as a Henschel mixer or a coffee mill may be used.

[Developer]

The toner of the present invention may be used as a one-component developer, a nonmagnetic one-component developer, and a two-component developer.

When used as a one-component developer, a nonmagnetic one-component developer or a magnetic one-component developer having a toner containing magnetic particles of about 0.1 to 0.5 μm may be used. Further, it may be mixed with a carrier and used as a two-component developer. In this case, conventionally known materials typified by iron-containing magnetic particles such as iron, ferrite, and magnetite may be used as the carrier magnetic particles. Particularly preferable are ferrite particles or magnetite particles. The volume average particle size of the carrier is preferably 15 to 100 μm, more preferably 20 to 80 μm.

Measurement of the median diameter D50 of the volume-based distribution of carriers may be measured using a laser diffraction particle size distribution measuring device “HELOS” (manufactured by Sympatec Inc.).

Preferably, the carrier is a coating carrier in which magnetic particles are further coated with a resin, or a so-called resin dispersion type carrier in which magnetic particles are dispersed in a resin. The resin composition for coating is not particularly limited, for example, an olefin resin, a styrene resin, a styrene-acrylic resin, a silicone resin, an ester resin, or a fluorine-containing polymer resin is used. Further, as a resin for constituting the resin dispersed carrier, it is possible to use a known one, and it is not particularly limited. For example, a styrene-acrylic resin, a polyester resin, a fluorocarbon resin, or a phenolic resin may be used.

The mixing ratio of the carrier and the toner is preferably in the range of carrier:toner=1:1 to 50:1 in terms of mass ratio.

[Image Forming System]

The image forming system of the present invention is an image forming system using the toner according to the present invention and the photoreceptor according to the present invention described above, and having at least a charging step, an exposure step, a developing step, a transfer step, and a cleaning step. That is, it is a system for forming an image by using the toner according to the present invention in an electrophotographic image forming apparatus (hereinafter, also simply referred to as an “image forming apparatus”) including a photoreceptor according to the present invention and capable of carrying out each of the above steps. The charging step, the exposure step, the developing step, the transfer step, and the cleaning step in the image forming system of the present invention are the same as those described in the image forming method of the present invention described above. An example of an image forming apparatus capable of implementing the image forming system of the present invention will be described below with reference to the drawings.

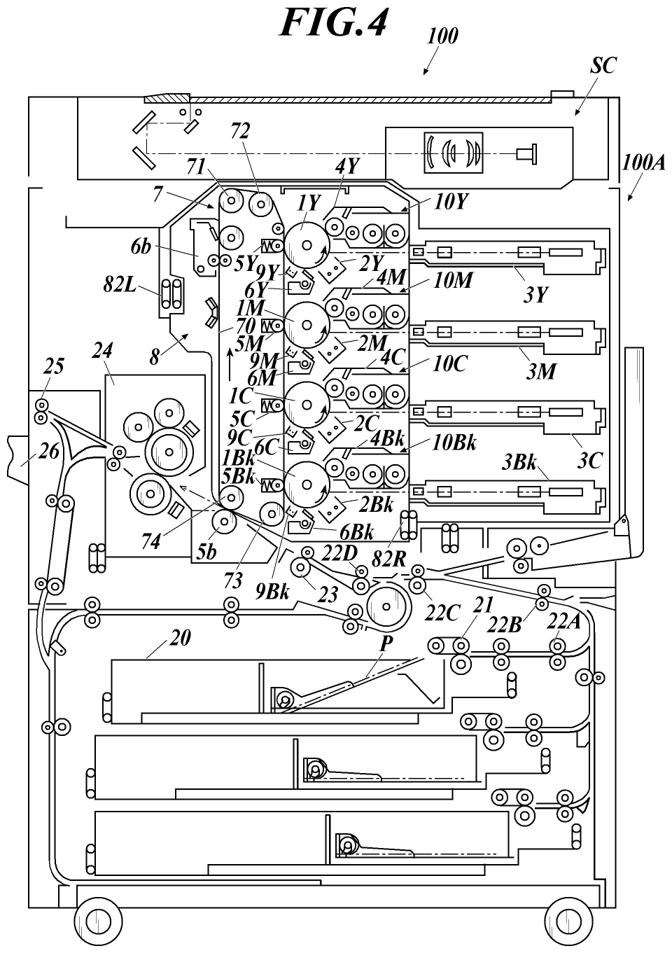

FIG. 4 is a cross-sectional schematic diagram showing a configuration of an example of an image forming apparatus according to the present invention. This image forming apparatus 100 is referred to as a tandem-type color image forming apparatus, and includes four sets of image forming sections (image forming units) 10Y, 10M, 10C and 10Bk which are arranged in a column in a vertical direction, an intermediate transfer unit 7, a sheet feeding device 21, and a fixing device 24. An original image reading apparatus SC is disposed above the main body 100A of the image forming apparatus 100.

The intermediate transfer member unit 7 includes an endless belt-shaped intermediate transfer member 70 rotatable by winding rollers 71, 72, 73, and 74, primary transfer rollers 5Y, 5M, 5C, and 5Bk, and a cleaning device 6b.

The four sets of image-forming units 10Y, 10M, 10C and 10Bk each respectively have drum-shaped photoreceptors 1Y, 1M, 1C and 1Bk at the center, and have charging devices 2Y, 2M, 2C and 2Bk arranged around the drum-shaped photoreceptor, exposing devices 3Y, 3M, 3C and 3Bk, rotating developing devices 4Y, 4M, 4C and 4Bk, and cleaning devices 6Y, 6M, 6C and 6Bk for cleaning the photoreceptors 1Y, 1M, 1C and 1Bk. The image forming apparatus 100 includes photoreceptors according to the present invention described above as photoreceptors 1Y, 1M, 1C and 1Bk.

The image forming units 10Y, 10M, 10C and 10Bk form toner images of yellow, magenta, cyan, and black toner images, respectively. In the image forming system of the present invention, the charging step, the exposure step, and the developing step are steps for forming a toner image on the photoreceptor. In the image forming apparatus 100, the charging step, the exposure step, and the developing step are performed as follows using the photoreceptors 1Y, 1M, 1C and 1Bk according to the present invention and the toner according to the present invention on the image forming units 10Y, 10M, 10C, and 10Bk. The toner may be mixed with the carrier as described above and used as a two-component developer.

The image forming units 10Y, 10M, 10C, and 10Bk have the same configuration, except that the colors of the toner images respectively formed on the photoreceptors 1Y, 1M, 1C, and 1Bk differ, and will be described in detail by exemplifying the image forming unit 10Y.

In the image forming unit 10Y, a charging device 2Y, an exposing device 3Y, a developing device 4Y, and a cleaning device 6Y are arranged around a photoreceptor 1Y which is an image forming member, and a yellow (Y) toner image is formed on the photoreceptor 1Y. In the present embodiment, at least the photoreceptor 1Y, the charging device 2Y, the developing device 4Y, and the cleaning device 6Y are integrated in the image-forming unit 10Y.

The charging device 2Y is a device that applies a uniform potential to the p photoreceptor 1Y. In the present invention, the charging device may be a contact-type roller charging system.

The exposing device 3Y is a device for performing exposure on the photoreceptor 1Y given a uniform potential by the charging device 2Y on the basis of an image signal (yellow) to form an electrostatic latent image corresponding to the yellow image, and as the exposing device 3Y, an LED in which light emitting elements are arranged in an array in the axial direction of the photosensitive element and an imaging element, or a laser optical system is used.

The developing device 4Y comprises, for example, a developing sleeve having a built-in magnet and rotating while holding a two-component developer, and a voltage applying device for applying a DC and/or AC bias voltage between the photoreceptor 1Y and the developing sleeve.

The cleaning device 6Y is constituted by a cleaning blade in which a tip is provided so as to abut on a surface of the photoreceptor 1Y and a brush roller in contact with a surface of the photoreceptor 1Y disposed at an upstream side of the cleaning blade. The cleaning blade has a function of removing residual toners adhering to the photoreceptor 1Y and a function of rubbing the surfaces of the photoreceptor 1Y.

The brush roller has a function of removing the residual toner adhering to the photoreceptor 1Y, a function of collecting the residual toner removed by the cleaning blade, and a function of rubbing the surface of the photoreceptor 1Y. That is, the brush roller contacts the surface of the photoreceptor 1Y, and in the contact portion, the traveling direction of the brush roller rotates in the same direction as the photoreceptor 1Y to remove the residual toner or paper powder on the photoreceptor 1Y and to convey and collect the residual toner removed by the cleaning blade.

Here, in the photoreceptor according to the present invention, since the universal hardness value HU of the outermost surface layer of the photoreceptor is 170 N/mm² or more, and the elastic deformation ratio of the photoreceptor is 40% or more, the surface of the photoreceptor has high hardness and high elasticity, and the surface of the photoreceptor is hardly deteriorated by scratches, wear, or discharges, and the cleaning property becomes good. Further, since the toner according to the present invention contains the toner base particles of a core-shell structure having a shell layer of 10% by mass or less with respect to the mass of the toner base particle on an outside of the resin constituting the core particle, and the solubility parameter value (SPs) of the resin constituting the shell layer is 10.75 or less. As a result, a shell layer becomes a thin layer, and it is possible to achieve both low-temperature fixing property and heat-resistant storage property, and the toner surface becomes hydrophobic, and the adhesion of the toner to the photoreceptor having a hydrophilic surface is reduced to improve the transferability. As described above, by combining the photoreceptor having the universal hardness of not less than 170 N/mm² and the elastic deformation ratio of not less than 40% with the toner having a thin shell layer and a solubility parameter value of 10.75 or less for the resin that constitutes the shell layer, in the contact charging method, it is possible to stably form a high-quality image having excellent low-temperature fixing property, transfer property, and cleaning property over a long period of time.

In the image forming system using the image forming apparatus 100, the transfer step of transferring the toner image formed on the photosensitive member to the transfer material is a mode in which the toner image is primarily transferred onto the intermediate transfer member using the intermediate transfer member and then the toner image is secondarily transferred onto the transfer material as described below.

The toner images of the respective colors formed by the image forming unit 10Y, 10M, 10C, and 10Bk are sequentially transferred onto the rotating endless belt-shaped intermediate transfer member 70 of the intermediate transfer member unit 7 by the primary transfer rollers 5Y, 5M, 5C, and 5Bk as a primary transfer device, and a synthesized color image is formed. The endless belt-shaped intermediate transfer member 70 is a semi-conductive endless belt-shaped second image carrier which is wound around and rotatably supported by a plurality of rollers 71, 72, 73 and 74.

The color image synthesized on the endless belt-shaped intermediate transfer member 70 is then transferred to a transfer material P such as plain paper or transparent sheet, which is an image support carrying a fixed final image. Specifically, the transfer material P accommodated in the paper feed cassette 20 is fed by the paper feed device 21, and is conveyed to the secondary transfer roller 5b as the secondary transfer device via a plurality of intermediate rollers 22A, 22B, 22C, 22D and registration rollers 23. Then, the color image is transferred (secondarily transferred) from the endless belt-shaped intermediate transfer member 70 onto the transfer material P at a time by the secondary transfer roller 5b. The transfer material P on which the color image has been transferred is subjected to a fixing process by the fixing device 24, and the transfer material P is pinched by the sheet discharge roller 25 and placed on the sheet discharge tray 26 outside the apparatus.

The fixing device 24 may use, for example, a heat roller fixing method including a heating roller having a heating source therein, and a pressure roller provided in a state of being pressed against the heating roller so that a fixing nip portion is formed on the heating roller.

On the other hand, after the color image is transferred onto the transfer material P by the secondary transfer roller 5b as the secondary transfer device, the residual toner is removed from the endless belt-shaped intermediate transfer member 70 in which the transfer material P is separated by curvature by the cleaning device 6b.

During the image-forming process, the primary transfer roller 5Bk is always in contact with the photoreceptor 1Bk. The other primary transfer rollers 5Y, 5M, and 5C are in contact with the corresponding photoreceptor 1Y, 1M, or 1C only when forming color images. The secondary transfer roller 5b comes into contact with the endless belt-like intermediate transfer member 70 only when the secondary transfer is performed by passing the transfer material P therethrough.

In the image forming apparatus 100, a housing 8 including the image forming units 10Y, 10M, 10C, and 10Bk and the intermediate transfer member unit 7 may be pulled out from the apparatus main body A via the support rails 82L and 82R.

Although an image forming system in a color laser printer has been described using the image forming apparatus 100 shown in FIG. 4, the image forming system of the present invention is also applicable to a monochrome laser printer or a copier. The exposure light source may also be a light source other than a laser, for example, an LED light source.

While embodiments of the present invention have been described above, the present invention is not limited to the above-described embodiments, and various modifications may be made.

### EXAMPLES

Hereinafter, the present invention will be specifically described with reference to Examples, but the present invention is not limited thereto. In the examples, the operation was done at room temperature (25° C.) unless otherwise specified, and the term “parts” or “%” indicates “parts by mass” or “% by mass”, respectively.

[Preparation of Photoreceptor 1]

A photoreceptor was prepared according to the following procedure.

(1) Preparation of a Conductive Support

A surface of a drum-shaped aluminum support (outer diameter φ30 mm, length 360 mm) was cut to prepare a conductive support having a surface roughness Rz of 1.5 μm.

(2) Formation of an Intermediate Layer

Then, the following components were dispersed in the following amounts to prepare a first coating liquid. At this time, a sand mill was used as a disperser, and dispersion was carried out for 10 hours by a batch method. Polyamide resin: 1 part by mass

Titanium oxide: 1.1 parts by mass

Ethanol: 20 parts by mass

X1010 (manufactured by Daicel Degussa Corporation) was used as a polyamide resin (resin binder), and SMT500SAS (manufactured by Tayca Corporation) was used as titanium oxide (conductive particles). The number average primary particle diameter of titanium oxide was 0.035 μm.

On the outer peripheral surface of the conductive support, the prepared first coating liquid was applied by a dip coating method, and dried in an oven at 110° C. for 20 minutes. Thus, an intermediate layer having a thickness of 2 μm was formed on the surface of the conductive support.

(3) Formation of a Charge Generating Layer

Then, the following components were mixed and dispersed in the following amounts to prepare a second coating liquid. At this time, a sand mill was used as a disperser, and dispersion was performed for 10 hours.

Titanyl phthalocyanine pigment: 20 parts by mass

Polyvinyl butyral resin: 10 parts by mass

t-Butyl acetate: 700 parts by mass

4-Methoxy-4-methyl-2-pentanone: 300 parts by mass

The titanyl phthalocyanine pigment (charge generating material) has a maximum diffraction peak at a position of at least 27.3° as measured by Cu-Kα characteristic X-ray diffraction spectrum. Further, #6000-C (manufactured by Denka Co., Ltd.) was used as the polyvinyl butyral resin (resin binder).

On the intermediate layer, the prepared second coating liquid was applied by a dip coating method, and dried in an oven at room temperature for 10 minutes. Thus, a charge generating layer having a thickness of 0.3 μm was formed on the surface of the intermediate layer.

(4) Formation of a Charge Transport Layer

The following components were mixed and dissolved in the following amounts to prepare a third coating liquid.

Charge transport material: 70 parts by mass

Resin binder: 100 parts by mass

Antioxidant: 8 parts by mass

Mixed solvent of tetrahydrofuran/toluene (mass ratio of 8/2): 750 parts by mass

4,4′-Dimethyl-4″-(β-phenylstyryl)triphenylamine) was used as a charge transporting material. As a resin binder for the charge-transporting layer, bisphenol Z-type polycarbonate (Iupilon™-Z300, manufactured by Mitsubishi Gas Chemical Co., Ltd.) was used. As an antioxidant Irganox™ 1010 (manufactured by BASF Co. Ltd.) was used.

On the charge generating layer, the prepared third coating liquid was applied by a dip coating method, and dried in an oven at 120° C. for 70 minutes. Thus, a charge transport layer having a thickness of 20 μm was formed on the surface of the charge generating layer.

(5) Formation of a Surface Protective Layer OC-1

The following components were used as components of a coating liquid for a surface protective layer.

Resin binder: 20 parts by mass

Polymerization initiator: 5 parts by mass

Charge transport material CT-1: 80 parts by mass

Mixed solvent of tetrahydrofuran/2-butanol (mass ratio of 10/1): 440 parts by mass

As a resin binder (polyfunctional radically polymerizable compound) for a surface protective layer, trimethylpropane trimethacrylate (SR350, manufactured by Sartomer Japan, Inc.) was used. As a polymerization initiator, a photopolymerization initiator (Irgacure 819, manufactured by BASF Japan Co., Ltd.) was used.

The surface protective layer coating liquid was applied to the outer peripheral surface of the conductive support having the charge transport layer formed on the surface thereof using a circular slide hopper coating apparatus, and then irradiated with ultraviolet rays for 1 minute using a metal halide lamp. As a result, a surface protective layer OC-1 having a thickness of 3.0 μm was formed on the surface of the charge transport layer to obtain a photoreceptor 1.

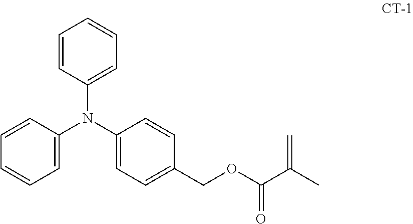 [SMILES: C=C(C)C(=O)OCc1ccc(N(c2ccccc2)c2ccccc2)cc1]

[Preparation of Photoreceptor 2]

A photoreceptor 2 was prepared in the same manner as preparation of the photoreceptor 1, except that the charge transport material CT-2 shown below was used to form a surface protective layer OC-2 instead of the charge transport material CT-1 in “(5) Formation of a surface protective layer OC-1”.

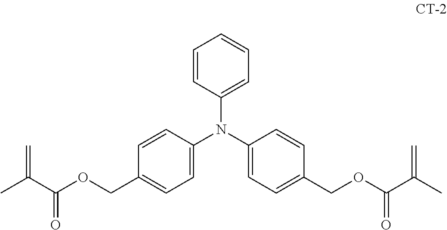 [SMILES: C=C(C)C(=O)OCc1ccc(N(c2ccccc2)c2ccc(COC(=O)C(=C)C)cc2)cc1]

[Preparation of Photoreceptor 3]

A photoreceptor 3 was prepared in the same manner as the preparation of the photoreceptor 1, except that “(5) Formation of a surface protective layer OC-1” was replaced with “(5) Formation of a surface protective layer OC-3” shown below.

(5) Formation of a Surface Protective Layer OC-3

The following components were mixed and dissolved in the following amounts to prepare a surface protective layer coating liquid.

Charge transport material CT-3: 50 parts by mass

Resin binder: 100 parts by mass

Antioxidant: 8 parts by mass

Mixed solvent of tetrahydrofuran/toluene (mass ratio of 8/2): 1000 parts by mass

As a resin binder for a surface protective layer, bisphenol Z-type polycarbonate (Iupilon-Z300, manufactured by Mitsubishi Gas Chemical Co., Ltd.) was used. As an antioxidant, Irganox™ 1010 (manufactured by BASF Co. Ltd.) was used.

The surface protective layer coating liquid was applied to the outer peripheral surface of the conductive support having the charge transport layer formed on the surface thereof using a circular slide hopper coating apparatus, and then irradiated with ultraviolet rays for 1 minute using a metal halide lamp. As a result, a surface protective layer OC-3 having a thickness of 3.0 μm was formed on the surface of the charge transport layer to obtain a photoreceptor 3.

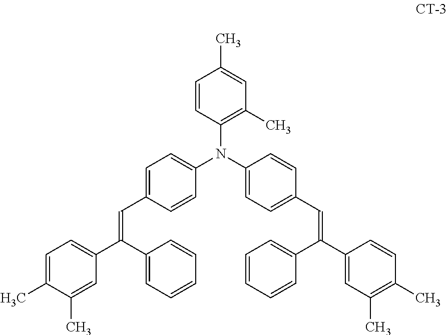

[Preparation of Photoreceptor 4]

A photoreceptor 4 was prepared in the same manner as the preparation of the photoreceptor 1, except that “(5) Formation of a surface protective layer OC-1” was replaced with “(5) Formation of a surface protective layer OC-4” shown below.

(5) Formation of a Surface Protective-Layer OC-4

A surface protective layer coating liquid in which 20 parts by mass of silica particles (RX-50; manufactured by Nippon Aerosil Co., Ltd.) were further dispersed in the surface protective layer coating liquid in the formation of the surface protective layer OC-3 was prepared. Other than that, a surface protective layer OC-4 was formed in the same manner to obtain a photoreceptor 4.

[Preparation of Photoreceptor 5]

A photoreceptor 5 was prepared in the same manner as the preparation of the photoreceptor 1, except that “(5) Formation of a surface protective layer OC-1” was replaced with “(5) Formation of a surface protective layer OC-5” shown below.

(5) Formation of a Surface Protective Layer OC-5

The following components were used as components of the coating liquid for a surface protective layer.

Resin binder: 100 parts by mass

Polymerization initiator: 10 parts by mass

Charge transport material CT-4: 30 parts by weight of 30

Conductive particles A: 40 parts by mass

Mixed solvent of tetrahydrofuran/2-butanol (mass ratio of 10/1): 440 parts by mass.

As a resin binder (polyfunctional radically polymerizable compound) for a surface protective layer, trimethylpropane trimethacrylate (SR350; Sartomer Japan, Inc.) was used. As a polymerization initiator, a photopolymerization initiator (Irgacure 819, manufacture by BASF Japan Co., Ltd.) was used. As conductive particles A, surface-treated tin oxide (SnO₂; mean particle size: 100 nm) was used.

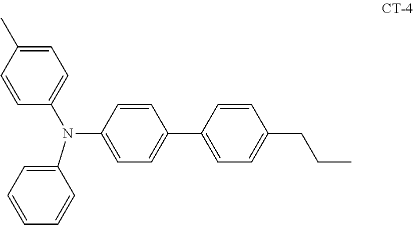 [SMILES: CCCc1ccc(-c2ccc(N(c3ccccc3)c3ccc(C)cc3)cc2)cc1]

30 parts by mass of the charge transport material, 40 parts by mass of the conductive particles A, 100 parts by mass of the resin binder for a surface protective layer, and 440 parts by mass of a mixed solvent of tetrahydrofuran/2-butanol (mass ratio of 10/1) were mixed under shielding from light and dispersed for 5 hours using a sand mill as a disperser. Then, 10 parts by mass of a polymerization initiator was added and stirred under light shielding to dissolve, thereby preparing a surface protective layer coating liquid. The coating liquid of a surface protective layer was applied to the outer peripheral surface of the conductive support having the charge transport layer formed on the surface thereof using a circular slide hopper coating apparatus, and then irradiated with ultraviolet rays for 1 minute using a metal halide lamp. As a result, a surface protective layer OC-5 having a thickness of 3.0 μm was formed on the surface of the charge transport layer, and a photoreceptor 5 was obtained.

[Preparation of Photoreceptor 6]

A photoreceptor 6 was prepared in the same manner as the preparation of the photoreceptor 1, except that “(5) Formation of a surface protective layer OC-1” was replaced with “(5) Formation of a surface protective layer OC-6” shown below.

(5) Formation of a Surface Protective Layer OC-6

The following components were used as components of the coating liquid for a surface protective layer.

Resin binder: 100 parts by mass

Polymerization initiator: 10 parts by mass

Conductive particles A: 70 parts by mass

Conductive particles B: 30 parts by mass

Mixed solvent of tetrahydrofuran/2-butanol (mass ratio of 10/1): 440 parts by mass.

As a resin binder (polyfunctional radically polymerizable compound) for a surface protective layer, trimethylpropane trimethacrylate (SR350; Sartomer Japan, Inc.) was used. As a polymerization initiator, a photopolymerization initiator (Irgacure 819, manufactured by BASF Japan Co., Ltd.) was used. As conductive particles A, surface-treated tin oxide (SnO₂; mean particle size: 100 nm) was used. As conductive particles B, surface-treated tin oxide (SnO₂; mean particle size: 20 nm) was used.

70 parts by mass of the conductive particles A, 30 parts by mass of the conductive particles B, 100 parts by mass of the resin binder for a surface protective layer, and 440 parts by mass of a mixed solvent of tetrahydrofuran/2-butanol (mass ratio of 10/1) were mixed under light shielding, and dispersed for 5 hours using a sand mill as a disperser. Then, 10 parts by mass of the polymerization initiator was added and stirred under light shielding to dissolve, thereby preparing a surface protective layer coating liquid. The coating liquid of a surface protective layer was applied to the outer peripheral surface of the conductive support having the charge transport layer formed on the surface thereof using a circular slide hopper coating apparatus, and then irradiated with ultraviolet rays for 1 minute using a metal halide lamp. As a result, a surface protective layer OC-6 having a thickness of 3.0 μm was formed on the surface of the charge transport layer, and a photoreceptor 6 was obtained.

[Preparation of Photoreceptor 7]

A photoreceptor 7 was prepared in the same manner as the preparation of the photoreceptor 1, except that a surface protection layer OC-7 was formed by applying a coating liquid for a surface protective layer by using a circular slide hopper coating apparatus, and then UV light was irradiated for 40 seconds by using a metal halide lamp instead of “(5) Formation of a surface protective layer OC-1”.

[Preparation of Photoreceptor 8]

A photoreceptor 8 was prepared in the same manner, except that “(5) Formation of a surface protective layer OC-3” in the preparation of the photoreceptor 3 was replaced with “(5) Formation of a surface protective layer OC-8” shown below.

(5) Formation of a Surface Protective Layer OC-8

A surface protective layer OC-8 was formed in the same manner except that the charge transport material in the surface protective layer OC-3 was replaced with 4,4′-dimethyl-4″-(0-phenylstyryl)triphenylamine) to obtain a photoreceptor 8.

[Preparation of Photoreceptor 9]

A photoreceptor 9 was produced in the same manner as the preparation of the photoreceptor 8, except that “(5) Formation of a surface protective layer OC-8” was replaced with “(5) Formation of a surface protective surface layer OC-9” shown below.

(5) Formation of a Surface Protective Surface Layer OC-9

A surface protective layer coating liquid in which 20 parts by mass of silica particles (RX-50; manufactured by Nippon Aerosil Co., Ltd.) were further dispersed in the surface protective layer coating liquid in the formation of the surface protective layer OC-8 was prepared. Other than that, a surface protective layer OC-9 was formed in the same manner to obtain a photoreceptor 9.

[Production of Toner]

(1) Preparation of a Resin Particle Dispersion Liquid for Core Particles (C-1)

A monomer mixture liquid consisting of 146 g of styrene, 88 g of n-butyl acrylate, 16 g of methacrylic acid, and 4.05 g of n-octyl-3-mercaptopropionate was placed in a stainless steel kettle fitted with a stirrer, to which 100 g of pentaerythritol tetrabehenate was added, warmed to 70° C., and dissolved to prepare a monomer mixture liquid. On the other hand, a surfactant solution obtained by dissolving 2 g of sodium polyoxyethylene (2) dodecyl ether sulfate in 1350 g of ion-exchanged water was heated to 70° C., and the monomer mixture liquid was added and mixed, and then the dispersion was carried out by a mechanical disperser CLEARMIX (manufactured by M Technique Co., Ltd.) having a circulation path for 30 minutes to prepare an emulsified dispersion. Then, an initiator solution in which 3 g of potassium persulfate was dissolved in 150 g of ion-exchanged water was added to this dispersion, and the polymerization was carried out by heating and stirring this system at 78° C. for 1.5 hours to prepare resin particles. To this resin particle, a polymerization initiator solution in which 7.38 g of potassium persulfate was further dissolved in 220 g of ion-exchanged water was added, and a monomer mixed liquid consisting of 265 g of styrene, 160 g of n-butyl acrylate, 30 g of methacrylic acid, and 5.46 g of n-octyl-3-mercaptopropionate was added dropwise over a period of 1 hour under a temperature condition of 80° C. After completion of the dropwise addition, heating stirring was performed for 2 hours to proceed the polymerization, and then cooled to 28° C. to obtain a resin particle dispersion. This resin particle dispersion is referred to as a “resin particle dispersion for core particles (C-1)”. The SP value of the obtained resin was 10.48, and the glass transition temperature Tg was 30° C.

(2) Preparation of a Colorant Particle Dispersion Liquid 1

90 g of sodium dodecyl sulfate was charged into 1600 g of ion-exchanged water and stirred and dissolved. While stirring this solution, 420 g of carbon black (Regal 330R, manufactured by Cabot Co., Ltd.) was gradually added. Then, a colorant particulate dispersion was prepared by subjecting to a dispersion treatment using a mechanical disperser CLEARMIX (manufactured by M Technique Co., Ltd.). This was referred to as a “colorant particle dispersion liquid 1”.

(3-1) Preparation of a Resin Particle Dispersion Liquid for Shell (S-1)

After adding 416 g of ion-exchanged water and 1 g of sodium dodecyl sulfate into a four-necked reaction vessel fitted with a stirrer, a cooling pipe and a temperature sensor, the temperature in the system was raised to 80° C. Subsequently, a polymerization initiator solution in which 1.44 g of potassium persulfate was dissolved in 64 g of ion-exchanged water was added, and then a mixture of the following polymerizable monomers mixture (m-1) and 1.95 g of n-octylmercaptan was added dropwise over 80 minutes to perform a polymerization reaction. After the mixture was dropped, the temperature in the system was maintained for 60 minutes and then cooled to room temperature, and filtration was performed to prepare resin particles. No polymerization residue was found in the system after the reaction, and it was confirmed that the resin particles were stably produced. The obtained resin particle dispersion liquid was used as a “resin particle dispersion liquid for shell (S-1)”. The SP value of this resin was 9.77, and the glass transition temperature Tg was 58.8° C.

(Composition of a Mixture of Polymerizable Monomers (m-1))

Methyl methacrylate: 82.8 g

2-Ethylhexyl methacrylate: 37.2 g

(3-2) Preparation of a resin particle dispersion liquid for shell (S-2)

In preparing the resin particle dispersion liquid for shell (S-1), a resin particle dispersion liquid for shell (S-2) was prepared using the following mixture (m-2) instead of the mixed (m-1) of the polymerizable monomers. The SP value of this resin was 9.81, and the glass transition temperature Tg was 57.0° C.

(Composition of a Mixture of Polymerizable Monomers (m-2))

Styrene: 3.6 g

Methyl methacrylate: 75.6 g

2-Ethylhexyl methacrylate: 39.6 g

Methacrylic acid: 1.2 g

(3-3) Preparation of a Resin Particle Dispersion Liquid for Shell (S-3)

In preparing the resin particle dispersion liquid for shell (S-1), a resin particle dispersion liquid for shell (S-3) was prepared using the following mixture (m-3) instead of the mixture (m-1) of the polymerizable monomers. The SP value of this resin was 10.61, and the glass transition temperature Tg was 71.4° C.

(Composition of a Mixture of Polymerizable Monomers (m-3))

Styrene: 93.6 g

2-Ethylhexyl acrylate: 18.0 g

Methacrylic acid: 8.4 g

(3-4) Preparation of a Resin Particle Dispersion Liquid for Shell (S-4)

In preparing the resin particle dispersion liquid for shell (S-1), a resin particle dispersion liquid for shell (S-4) was prepared using the following mixture (m-4) instead of the mixture (m-1) of the polymerizable monomers. The SP value of this resin was 10.61, and the glass transition temperature Tg was 71.4° C.

(Composition of a Mixture of Polymerizable Monomers (m-4))

Styrene: 80.3 g

2-Ethylhexyl acrylate: 25.3 g

Methacrylic acid: 14.4 g

(3-5) Preparation of a Resin Particle Dispersion Liquid for Shell (S-5)

In preparing the resin particle dispersion liquid for shell (S-1), a resin particle dispersion liquid for shell (S-5) was prepared using the following mixture (m-5) instead of the mixture (m-1) of the polymerizable monomers. The SP value of this resin was 10.74, and the glass transition temperature Tg was 78.8° C.

(Composition of a Mixture of Polymerizable Monomers (m-5))

Styrene: 89.4 g

2-Ethylhexyl acrylate: 16.2 g

Methacrylic acid: 14.4 g

(3-6) Preparation of a Resin Particle Dispersion Liquid for Shell (S-6)

In preparing the resin particle dispersion liquid for shell (S-1), a resin particle dispersion liquid for shell (S-6) was prepared using the following mixture (m-6) instead of the mixture (m-1) of the polymerizable monomers. The SP value of this resin was 10.23, and the glass transition temperature Tg was 64.5° C.

(Composition of a Mixture of Polymerizable Monomers (m-6))

Styrene: 40.3 g

Methyl methacrylate 33.5 g

2-Ethylhexyl methacrylate: 37.6 g

Methacrylic acid: 1.2 g

(3-7) Preparation of a Resin Particle Dispersion Liquid for Shell (S-7)

In preparing the resin particle dispersion liquid for shell (S-1), a resin particle dispersion liquid for shell (S-7) was prepared using the following mixture (m-7) instead of the mixture (m-1) of the polymerizable monomers. The SP value of this resin was 10.8, and the glass transition temperature Tg was 81.3° C.

(Composition of a Mixture of Polymerizable Monomers (m-7))

Styrene: 92.7 g

2-Ethylhexyl acrylate: 12.5 g

Methacrylic acid: 14.4 g

(4) Preparation of a Toner Base Particle Dispersion Liquid 1

To a 5 L reaction vessel fitted with a stirrer, a temperature sensor, a cooling pipe, and a nitrogen introducing device, 348 g of the resin particle dispersion liquid for core (C-1) in terms of solid content, 1100 g of ion-exchanged water, and 200 g of “the colorant dispersion liquid 1” were charged, and after the liquid temperature was adjusted to 30° C., an aqueous sodium hydroxide solution of 5 mol/L was added to adjust the pH to 10. Then, an aqueous solution obtained by dissolving 60 g of magnesium chloride in 60 g of ion-exchanged water was added over 10 minutes at 30° C. under stirring. Heating was started after holding for 3 minutes, the system was heated to 80° C. over 60 minutes, and the particle growth reaction was continued while holding 80° C. In this state, the particle size of the associated particles was measured with “Coulter Multisizer III”, and when the median diameter on a volume basis reached 6 μm, an aqueous solution prepared by dissolving 40 g of sodium chloride in 160 g of ion-exchanged water was added to stop particle growth. Further, the fusion between particles was allowed to proceed by heating and stirring at a liquid temperature of 80° C. for 1 hour as a ripening step to form “core particles”. Then, 21.6 g of the resin particle dispersion liquid for shell (S-1) was added to the surface of the “core particles” in terms of solid content, and stirring was continued for 1 hours at 80° C., and the resin particles for shell were fused to the surface of the toner base particles to form a shell layer. Here, an aqueous solution in which 150 g of sodium chloride was dissolved in 600 g of ion-exchanged water was added and subjected to a ripening treatment, and the mixture was cooled to 30° C. at a time when the average circularity became 0.925 measured using the aforementioned FPIA-2100 (the number of HPF detected was 4000), thereby producing a toner base particle dispersion liquid 1.

(5) Preparation of Toner Base Particle Dispersion Liquids 2 to 7

In the preparation of the toner base particle dispersion 1, toner base particle dispersions 2 to 7 were prepared in the same manner except that the resin particle dispersion liquid for shell (S-1) was changed as shown in Table I below, respectively.

(6) Preparation of Toner Base Particle Dispersion Liquids 8 and 9

Toner base particle dispersion liquids 8 and 9 were prepared in the same manner as the preparation of the toner base particle dispersion liquid 1, except that 35.3 g and 47.1 g of the resin particle dispersion liquid for shell (S-1), respectively, were added instead of adding 21.6 g of the resin particle dispersion liquid for shell (S-1) in terms of solid content to form a shell layer of 9% by mass and 12% by mass, respectively.

(7) Production of Toners 1 to 9

Toner base particle dispersion liquids 1 to 9 were subjected to the following treatments to produce toners 1 to 9. The respective toner base particle dispersions were subjected to solid-liquid separation in a basket-type centrifugal separator “MARKIII Model No. 60×40” (manufactured by Matsumoto Mechanical Co., Ltd.) to form a wet cake of toner base particles. The wet cake was washed with ion-exchanged water at 40° C. until the electric conductivity of the filtrate became 5 μS/cm in the basket type centrifuge, and then transferred to a “flash jet dryer” (manufactured by Seishin Enterprise Co., Ltd.) and dried until the moisture content became 0.5% by mass to obtain toner base particles. Then, to the obtained toner base particles, 1% by mass of hydrophobic silica (number average primary particle diameter=12 nm) and 0.3% by mass of hydrophobic titania (number average primary particle diameter=20 nm) were added and mixed by a Henschel mixer to prepare toners 1 to 9.

(8) Production of Developers 1 to 9

Developers 1 to 9 were produced by the following procedure using toners 1 to 9. Ferrite carriers with a volume average particle diameter of 60 μm coated with silicone resin were mixed with each of the toner particles to prepare developers 1 to 9 with a toner concentration of 6%.

For each of the obtained photoreceptors, the universal hardness value and the elastic deformation ratio were calculated according to the following. Also, for each toner, the solubility parameter values of the resin constituting the shell layer and the core particle were calculated, respectively.

The universal hardness value and the elastic deformation ratio were measured at arbitrary five points from the image forming region in the outermost surface layer of the photoreceptor as shown below, and the average value thereof was obtained.

(Calculation Method of Universal Hardness Value (HU))

The universal hardness value (HU) was measured using an ultra-micro hardness meter “H-100V” (manufactured by Fischer Instruments K.K.) under the following measuring condition, and the universal hardness value was calculated by the above-mentioned equation (1) and equation (2).

<Measurement Conditions>

Measuring instrument: Ultra-micro hardness meter “H-100V” (manufactured by Fischer Instruments K.K.)

Indenter shape: Vickers indenter (a=136°)

Measurement environment: 25° C., relative humidity 50% RH

Maximum test load: 2 mN

Load speed: 2 mN/10 sec

Maximum load creep time: 5 seconds

Removal speed: 2 mN/10 sec

(Calculation Method of Elastic Deformation Ratio)

The elastic deformation ratio was obtained by using a Fischer Scope H-100 (manufactured by Fischer Instruments K.K.) under conditions of 25° C. and 50% RH. When a Vickers quadrangular pyramid indenter was used to apply a load of 2 mN to the outermost layer and the lower layer of the photoreceptor at a load time of 10 seconds, with holding for 5 seconds, and then measure the indentation depth and load when unloaded for 10 seconds, it is expressed as shown in FIG. 1 (A→B→C).

The work of the elastic deformation Welast is expressed by the area surrounded by C-B-D-C in FIG. 1, the work of the plastic deformation Wplast is expressed by the area surrounded by A-B-C-A in FIG. 1, and the elastic deformation ratio (%) was obtained from (Welast/(Welast+Wplast)×100.

(Calculation Method of Solubility Parameter Value)

The solubility parameter value of each resin of the core particle and the shell layer constituting the toner base particles may be determined from the composition of the resin constituting the resin as described above, and the solubility parameter value of each resin was calculated from the product of the solubility parameter value and the molar ratio of each monomer constituting the resin. Details are omitted here. Further, among the solubility parameter value (SPc) of the resin constituting the core particle and the solubility parameter value (SPs) of the resin constituting the shell layer, an absolute value of the difference in solubility parameter value (SPc) of the core particle having the solubility parameter value farthest from the solubility parameter value of the shell layer (ΔSP=|(SPs)−(SPc)|) was also calculated. Note that the solubility parameter value (SPc) of the resin constituting the core particle was 10.48.

[Evaluation]

For the image forming apparatus, Bizhub™ C360 (manufactured by Konica Minolta, Inc.) was used. The Bizhub™ C360 is a tandem type color MFP (Multi-Function Peripheral) of a contact charging type, and employs laser exposure with a wavelength of 780 nm, intermediate transfer with reverse development. In the above image forming apparatus, using a combination of the photoreceptor and the toner shown in Table I below, an A4 size image having a print area ratio of 5% for each color of YMCK in an atmosphere of 20° C. and a humidity of 5% RH was produced on A4 size neutral paper. After printing out 100,000 sheets, the image of each photoreceptor was evaluated as follows.

<Transferability 1>

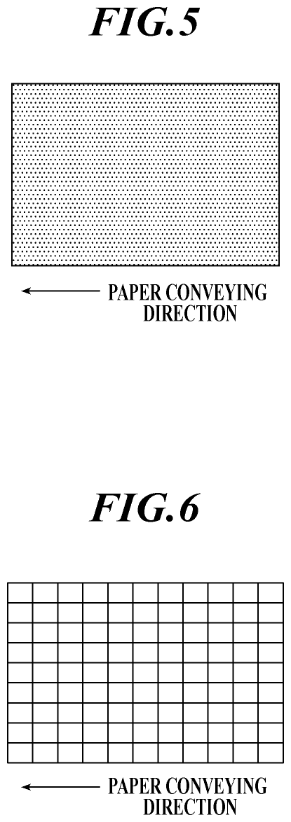

After performing the above-described durability test, a halftone image having a coverage ratio of 80% was formed with an internal mounting pattern No. 53/Dot 1 (typical exposure pattern formed in a dot-like shape having regularity) (see FIG. 5) in an environment of 30° C. and 80% RH, and the transfer rate of the toner transferred to the intermediate transfer member was measured.

(Evaluation Criteria)

AA: 95% or more (pass)

BB: 90% or more (pass)

CC: Less than 90% (rejected)

<Transferability 2>

After performing the above-described durability test, under the environment of 30° C. and 80% RH, the internal mounting pattern No. 53/Dot 1 (typical exposure pattern formed in a dot-like shape having regularity) was printed with a 6 dot lattice image on the A3 size neutral paper (see FIG. 6.). The printed grating image was visually observed and evaluated based on the following criteria.

(Evaluation Criteria)

AA: No loss or line width reduction is observed in the lattice image (pass)

BB: In the lattice image, a part of line width is slightly narrower, but there is no problem for practical use (pass).

CC: In the lattice image, a defect or line width narrowing is observed (failed).

<Cleaning Property>

After performing the above-described durability test, a halftone image (FIG. 5) having a coverage ratio of 80% was printed on an A3 size neutral paper so that the black background portion was located at the front portion and the white background portion were located at the rear portion in the paper conveying direction under an environment of 10° C. and 15% RH, the white background portion of the paper was visually observed, and the cleaning failure (toner slip-through) was evaluated based on the following criteria.

(Evaluation Criteria)

AA: No stain was found in the white background area (pass)

BB: A slight streaky stain occurred on the white background, but there was no problem for practical use (pass).

CC: Clear streaky stain occurred in the white background, and there was a practical problem (rejection).

<Fixability>

The surface temperature of the heating roller of the fixing device of the above evaluation machine was changed so that the surface temperature of the paper varied in increments of 10° C. in the range of 80 to 150° C., and a fixing image was produced by fixing the toner image at each changing temperature. In preparing the printed images, high-quality paper (80 g/m²) of A4 size was used. The fixing strength of the printed image obtained by fixing was evaluated using a method according to the mending tape peeling method described in Chapter 9, Section 1.4 of “Basics and Applications of Electrophotographic Technology: Electrophotographic Society”. Specifically, after a 2.54-square solid black print image having a 0.6 mg/cm² amount of toner adhered thereto was produced, the image density before and after the toner was peeled off was measured with a “Scotch Mending Tape” (manufactured by Sumitomo 3M Corporation), and the residual ratio of the image density was obtained as the fixing ratio. The “surface temperature of the transfer material (paper)” at which a fixing rate of 95% or more is obtained is defined as the minimum fixing temperature. The surface temperature of the transfer material (paper) was measured by a non-contact thermometer. Image density was measured using a reflection densitometer “RD-918” (manufactured by McBeth Corporation).

(Evaluation Criteria)

AA: Fixing is possible at a minimum fixing temperature of less than 95° C.

BB: Fixing is possible at a minimum fixing temperature of 95° C. or more and less than 105° C.

CC: Fixing is possible at a minimum fixing temperature of 105° C. or more and less than 120° C.

DD: Fixing is possible at a minimum fixing temperature of 120° C. or higher.

TABLE 1

| | Toner | | | | | | | | | | | | | |
|---|---|---|---|---|---|---|---|---|---|---|---|---|---|---|
| | | | | Sp | | Mass | Photoreceptor | | | | | | | |
| | | Toner | Resin | value | | ratio | | | | Elastic | Evaluation | | | |
| | | base | particle | of | | of shell | | | Universal | defor- | Trans- | Trans- | | |
| | | particle | dispersion | resin | Δ SP = | layer | | Surface | hardness | mation | fer- | fer- | | |
| | Toner | dispersion | liquid for | for | \|Sps- | [% by | | protective | value | ratio | ability | ability | Cleaning | Fix- |
| | No. | liquid | shell No. | shell | Spc\| | mass] | *1 | layer | [N/mm²] | [%] | 1 | 2 | property | ability |
| Example 1 | 1 | 1 | S-1 | 9.77 | −0.71 | 5.5 | 1 | OC-1 | 245 | 52 | AA | BB | AA | BB |
| Example 2 | 2 | 2 | S-2 | 9.81 | −0.67 | 5.5 | 1 | OC-1 | 245 | 52 | AA | AA | AA | BB |
| Example 3 | 3 | 3 | S-3 | 10.61 | 0.13 | 5.5 | 1 | OC-1 | 245 | 52 | AA | BB | AA | BB |
| Example 4 | 4 | 4 | S-4 | 10.69 | 0.21 | 5.5 | 1 | OC-1 | 245 | 52 | AA | AA | AA | BB |
| Example 5 | 5 | 5 | S-5 | 10.74 | 0.26 | 5.5 | 1 | OC-1 | 245 | 52 | AA | AA | AA | BB |
| Example 6 | 8 | 8 | S-5 | 10.74 | 0.26 | 9 | 1 | OC-1 | 245 | 52 | AA | AA | AA | BB |
| Example 7 | 6 | 6 | S-6 | 9.98 | −0.5 | 5.5 | 1 | OC-1 | 245 | 52 | AA | AA | AA | BB |
| Example 8 | 5 | 5 | S-5 | 10.74 | 0.26 | 5.5 | 2 | OC-2 | 275 | 55 | AA | AA | AA | BB |
| Example 9 | 5 | 5 | S-5 | 10.74 | 0.26 | 5.5 | 3 | OC-3 | 170 | 45 | BB | BB | AA | BB |
| Example 10 | 5 | 5 | S-5 | 10.74 | 0.26 | 5.5 | 4 | OC-4 | 200 | 40 | BB | BB | AA | BB |
| Example 11 | 5 | 5 | S-5 | 10.74 | 0.26 | 5.5 | 5 | OC-5 | 295 | 50 | BB | BB | BB | BB |
| Example 12 | 5 | 5 | S-5 | 10.74 | 0.26 | 5.5 | 6 | OC-6 | 280 | 62 | BB | BB | BB | BB |
| Example 13 | 5 | 5 | S-5 | 10.74 | 0.26 | 5.5 | 7 | OC-7 | 210 | 46 | AA | AA | AA | BB |
| Comparative | 9 | 9 | S-5 | 10.74 | 0.26 | 12 | 1 | OC-1 | 245 | 52 | BB | BB | AA | DD |
| Example 1 | | | | | | | | | | | | | | |
| Comparative | 7 | 7 | S-7 | 10.8 | 0.32 | 5.5 | 1 | OC-1 | 245 | 52 | CC | CC | AA | BB |
| Example 2 | | | | | | | | | | | | | | |
| Comparative | 5 | 5 | S-5 | 10.74 | 0.26 | 5.5 | 8 | OC-8 | 160 | 40 | BB | BB | CC | BB |
| Example 3 | | | | | | | | | | | | | | |
| Comparative | 5 | 5 | S-5 | 10.74 | 0.26 | 5.5 | 9 | OC-9 | 205 | 38 | BB | BB | CC | BB |
| Example 4 | | | | | | | | | | | | | | |

*1: Photoreceptor No.

As shown in the above results, it is recognized that the image forming method of the present invention is superior in transferability, cleaning property and low-temperature fixability as compared with the comparative example, and is also effective in preventing occurrence of void.

Although embodiments of the present invention have been described and illustrated in detail, the disclosed embodiments are made for purposes of illustration and example only and not limitation. The scope of the present invention should be interpreted by terms of the appended claims.

1. An image forming method using an electrophotographic photoreceptor and a toner for developing an electrostatic charge image, and having at least a charging step, an exposure step, a developing step, a transfer step and a cleaning step, wherein the charging step is a step using a contact charging device; in an outermost layer of the electrophotographic photoreceptor, a universal hardness value (HU) of the photoreceptor is 170 N/mm² or more, and an elastic deformation ratio of the photoreceptor is 40% or more when a Vickers indenter is used in an environment of 25° C. and a relative humidity of 50% and pushed by a maximum load of 2 mN; and the toner for developing an electrostatic charge image contains toner base particles of a core-shell structure having a shell layer of 10% by mass or less with respect to a mass of the toner base particle on an outside of a resin constituting a core particle, and a solubility parameter value (SPs) of a resin constituting the shell layer is 10.75 or less.

2. The image forming method described in claim 1, wherein a glass transition temperature of the resin constituting the shell layer is higher than a glass transition temperature of the resin constituting the core particle; and an absolute value of a difference (SPs)-(SPc) between a solubility parameter value of the resin constituting the shell layer (SPs) and a solubility parameter value of the resin constituting the core particle (SPc) is in the range of 0.20 to 0.70.

3. The image forming method described in claim 1, wherein the universal hardness value (HU) is in the range of 200 to 280 N/mm² and the elastic deformation ratio is in the range of 45 to 60%.

4. The image forming method described in claim 1, wherein the outermost layer of the electrophotographic photoreceptor contains a polymerized product of a charge transport material having a polymerizable reactive group.

5. An image forming system using a toner for developing an electrostatic charge image and an electrophotographic photoreceptor, and having at least a charging step, an exposure step, a developing step, a transfer step and a cleaning step, wherein the image forming method described in claim 1 is performed.
